(19) United States
(12) Patent Application Publication
(10) Pub. No.: US 2005/0048218 A1
(43) Pub. Date: Mar. 3, 2005

(54) Process for coating substrates with polymeric compositions

(76) Inventor: Larry G. Weidman, Ft. Myers, FL (US)

Correspondence Address: Isaac A. Angres, Suite 301, 2001 Jefferson Davis Highway, Arlington, VA, 22202, US

(21) Appl. No.: 10/650,973

(22) Filed: Aug. 29, 2003

(51) Int. Cl. B05D 1/08

(52) U.S. Cl. 427/446; 106/14.05

(57) ABSTRACT

Corrosion resistant non-polar polymer coatings and methods for applying the coatings to substrates are described, wherein a source of non-polar polymer powder is deposited as a coating onto the surface of a substrate by high temperature thermal spray. The non-polar character of the powder and any additives thereto is substantially preserved during the high temperature thermal spray process by the use, at one or more locations along the thermal spray route, of at least one non-oxidizing shielding gas, at least one reducing gas, or a combination of the two types of gases to displace or react with ambient oxygen. High velocity impact force (HVIF) spraying techniques are preferred. Similarly processes and materials for low permeability and non-corrosive HVIF coatings for steel fuel tanks are disclosed.

### FIELD OF THE INVENTION

The instant invention generally relates to steel containers, metallic and non-metallic substrates, and more particularly, to substrates of different mechanical configurations provided with a thermal spray generated coating, including high velocity impact fusion (HVIF) coatings. Still more particularly, the present invention provides a thermal spray generated porous or non-porous and impermeable coatings, for use on substrates such as steel containers and the like. The thermal spray processes of HVIF, including both chemical combustion spraying and electric heating spraying, use powder forms of active materials. For instance, the HVIF Thermoplastic Thermospray Process described in U.S. Pat. No. 5,285,967 issued Feb. 15, 1994, the entire contents of which are incorporated by reference can be used to spray a thermoplastic surface welded film coating to cover container walls i.d. (inner diameter) and/or o.d (outer diameter), Pinch Areas or Seam Welds, Fittings, as seals around fittings, fuel neck fittings and other Fuel System Components without overheating or deforming parts or plastic fuel tanks.

The present invention also relates to improvements (nozzles, polymers, parameters and fabricating production) to Weidman U.S. Pat. No. 5,285,967 High Velocity Thermospray Gun for Spraying plastic coatings, parameters for spraying of thermoplastic over thermoplastic substrates with the formation of chemical bonding, and in general to the field of low permeability containers, such as those used in vehicle fuel tanks. The present invention is particularly designed to improve low permeability containers with improved low permeability vessels, fitting seals, pinch areas and methods of production.

The present invention and methods can be utilized as well for containers that do not require low permeation characteristics. They will however benefit from other advantages made possible by the present invention such as improved chemical resistance, resilient structural integrity unaffected by non-volatile fluid vapors, and resistance to erosion, corrosion and abrasion.

The improved containers of the present invention are useful in all modes of self-propelled vehicles such as but not limited to cars and buses as well as marine, aerospace and recreational vehicles and trucks. Further, improved containers of the present invention can be used in other applications such as for chemical processing vessels, mobile chemical tanks, or stationary storage containers of fuel and other volatile liquids.

The present invention further relates to a method for improving resistance to fouling and/or corrosion of surfaces on metallic or non-metallic objects by application of an anti-foulant and/or anti-corrosion coating to the surface of said metallic or non-metallic objects using a thermal spray or HVIF coating technique. This invention is particularly applicable to external and internal coatings on containers, molds, and molded substrates. Of particular interest are applications in the construction of low permeation containers, e.g. plastic or steel fuel containers, in order to reduce or eliminate environmentally harmful emissions. The present invention also relates to methods and coating compositions for controlling foulant organisms on a substrate e.g. the hull of a ship.

The following U.S. patents are illustrative of related art: U.S. Pat. Nos. 5,285,967; 4,201,904; 5,041,713; 4,928,879 4,964,568; 5,014,915; 5,047,265; and 5,148,986.

### BACKGROUND OF THE INVENTION

The present invention relates generally to corrosion and/or foulant resistant coatings for metallic or nonmetallic substrates, and more particularly to novel non-polar or non-polarizable, polymeric, corrosion and/or foulant resistant coatings and a system and methods for applying these coatings. This invention further relates generally to improvements in the manufacture of low permeation containers, more specifically to fuel containers composed of plastics and/or steel.

Plastic Containers

A typical container assembly comprises a Plastic Fuel Tank made by conventional blow molding or thermoforming processing with multi-layer barrier technology. These vessels are prone to leaking hydrocarbons and fuel vapor in the vulnerable seam or pinch area. Lack of fusion and poor bonding can then result in causing a well designed multi-layered fuel tank to become useless because of leakage.

The hot plate welding process sandwiches two multi-layered or non-multi-layered thermoplastic pieces between two hot plates under heat and pressure. The parts are then cooled resulting in a bond mating of the two parts. No filler material is used in the process. The excess hot material is squeezed through the two hot plates and, once cooled, becomes excess trim or flash. Once the part or container is cooled it is removed from the plate/mold device, excess flash is removed, and any secondary finishing operations are performed.

Analysis of the cut cross section of pinch specimens cut out of tanks show hot plate pinch weld areas with a very thin fusion zone under microscopic power of 300×. The very thin fusion zone between conventional layers of EVOH-white and HDPE black contrast very well. The fusion zone is so small that under 300× there is no dilution or mixing of either the EVOH or HDPE together or to each other. No heat-affected zone can usually be detected at 300×. A scanning electron microscope at 1.5 angstrom does reveal some melting and blending of a lot of free radicals with very little consistency. Further, poor adhesion and lack of fusion is seen with non-compatible, multi-layered, dissimilar EVOH and HDPE multi-layers. The method of the present invention overcomes these failings of conventional plastic fuel containers.

Plastic storage containers provide a number of advantages over those made of other materials, such as reduced weight, reduced costs for both materials and construction and greater flexibility in shape. Along with these advantages, the ability of certain plastic containers to stretch or flex makes them useful in automotive applications as they are less likely to crack and leak in an accident. Mono-layer polyethylene fuel tanks, while benefitting from the aforementioned advantages, suffer from a comparatively high permeability to gasoline and synthetic blends when compared to containers formed of other materials and cannot meet U.S. Environmental Protection Agency (EPA) and State evaporative emission standards. For example, both the EPA and the California Air Resources Board (CARB) are requiring progressively tighter evaporative emission standards. Along with zero emissions vehicle (ZEV) and low emission vehicle (LEV) standards on board, refueling vapor recovery standards must be met. Conventional blow molding machines use only HDPE as the fabrication material for fuel tank construction.

By reducing evaporative emissions from fuel tank systems, vehicle manufacturers can earn partial credit toward meeting ZEV standards. Therefore, several approaches have been taken to improve the permeability characteristic of plastic fuel containers. One solution to this problem has been a fuel tank formed of multi-layer wall material that is composed of layers of polyethylene and an ethylene-vinyl alcohol (EVOH) co-polymer. Polyethylene-EVOH thermoplastic structures can be formed into a variety of container shapes with improved permeability characteristics using twin sheet thermoforming and blow molding techniques. Polyethylene-EVOH container walls typically have 5 to 7 layers. The basic 5 layers include polyethylene inner and outer layers and one EVOH layer with an adhesive layer on each side. An optional sixth layer is typically a “rigid” layer made up of a mixture of polyethylene, ethylene, vinyl alcohol (EVOH) and adhesive ground up from multi-layer materials left over from other manufacturing processes. An optional seventh layer may be a conductive layer of a material contact layer. Containers constructed using such multi-layer material have low permeability to hydrocarbons or other vapors contained therein.

Multi-layer technology HDPE tanks offer long-term structural integrity but will not meet EPA permeation requirements. The emergence of new technologies has been needed to enable the increased use of plastic gas tanks. These new technologies can be grouped into either multi-layer or barrier types.

Conventional HDPE fuel tanks are designed with up to six or seven barrier EVOH layers sandwiched between two layers of HDPE. Some manufacturers design to meet Calliformia's California's stricter evaporative fuel standards by including an inner layer of HDPE attached by an adhesive barrier layer of polyamide (nylon 12, nylon 11, nylon 66, etc.) or of ethylene-vinyl alcohol copolymer (EVA with Nylon 12) (EVA with ETFE). An additional adhesive layer attaches a layer of “regrind” and an outer layer of HDPE. Air Products and Chemicals of Allentown, Pa. has commercialized a fluorine based barrier technology that enables plastic fuel tank manufactures to meet more stringent emission standards. The Shed Test completed in 1992 on Airoguard plastic tanks produced by Kautex of Candad Canada indicated hydrocarbon permeation rates as low as 0.1 g/24 h are significantly lower than rates for tanks using previously available technology. The performance of the Airoguard tanks compares with multi-layer extrusion tanks while maintaining the long-term structural integrity of mono-layer tanks. Solvay Automotive has developed technology to keep HDPE tank emissions down to 0.2 g/24 h or less, even with Methanol containing fuels. Using technology called Solvay optimized fluorination, products are obtained that equal or exceed the permeation performance of products obtained by co-extrusion with an EVOH barrier resin. Solvay continues to add multi-layer capacity to meet new emission and customer standards. Aero Tec Laboratories of Ramsey, N.J. has developed a semi-flexible safety tank made from an olefin compound of polymers and anti-diffusion barrier additives.

The conventional multi-layers of EVOH sandwiched or glued by adhesive to HDPE are not resistant to hydrocarbons due to inadequate chemical bonding resulting in leakage through the layers. The chemical incompatibility of the differing layers prevents adequate fusion of the layers during the formation of the vessel. This lack of fusion in multi-layered materials is particularly problematic in the formation of the vulnerable pinch and seam areas. Hence substantial leakage occurs in these areas.

Steel Containers

Steel storage containers provide a number of advantages over those made of other materials, such as advantages regarding relative permeability to gasoline hydrocarbon fuel vaporization. Steel fuel tanks also provide high strength and are safer during under car fires. The cost of manufacturing is very competitive. Steel fuel tanks can meet U.S. Environmental Protection Agency (EPA) and State evaporative emissions standards

As noted above, both EPA and the California Air Resources Board (CARB) are requiring progressively tighter evaporative emission standards. Along with zero emissions vehicle (ZEV) and low emission vehicle (LEV) standards, on board refueling vapor recovery standards must be met. By reducing evaporative emissions from the fuel tank system, vehicle manufacturers can earn partial credit toward meeting ZEV standards.

Therefore, several approaches have been take to improve the permeability and corrosion characteristics of steel fuel containers. One solution to this problem of permeation of fuel hydrocarbons is to stop leakage at the vulnerable resistance welded seam area. Zinc, Nickel coated steel, aluminized zinc/aluminum coated steel pose welding problems. Seam welding is particularly prone to failure when welding surfaces of metal coated zinc/aluminum and steel together. The zinc aluminum coating creates porosity and pinholes in the seam weld zone.

North America auto manufactures are currently supplied with tanks comprised of a steel substrate coated with either terne (an alloy of nominally 85% lead and 15% tin) or zinc-nickel. In all, about 125,191 tons of steel substrate per year are used in gas tank production.

Stainless steel tanks have been tested and although effective for fuel (conventional and flexible) storage when finished, they are difficult to form without severe breakage occurring during stamping. Also stainless steel is expensive, over 5.1 times more expensive than terne steel.

Ten years is the usable life expectancy of electrocoated zinc-nickel products as containers for current fuels and flex fuels under typical exterior corrosive environments. However, zinc coated mild steel is prone to cracking, pinholes, inner gradual corrosion, and cracking during welding. Further the harmful vapors released during welding of zinc are a health hazard to personnel.

Hot dipped tin coating has also been found to be effective for resisting all fuels, but it does require a paint coating for exterior protection from road induced corrosion. This product welds faster (fewer welding problems) than painted terne and has better potential for good solderability than painted galvanneal and zinc nickel coated steel substrates. Hence it permits better attachments of fuel filler tubes and other lines than painted galvanneal and zinc nickel coated steel substrates. Nonetheless, despite these drawbacks of poor weldability, poor flexibility and hazardous processing, electrocoated Zn—Ni and Galvanneal have the advantages of low cost at high volumes, recyclability, effective inside and outside corrosion protection, practical materials and processing costs, and good permeability characteristics.

A further comparison of the advantages and disadvantages of other metal substrates reveals:

Hot Dipped Tin:

Advantages: Low cost at high volumes, recyclable, effective inside and outside corrosion protection, material cost, good permeability and weldability properties
Disadvantages: Shape flexibility failure and cracking during stamping operation, environmental hazard and harmful vapors produced by welding Stainless Steel:
Advantages: Corrosion resistance, recyclable and good permeability properties
Disadvantages: High cost at all volumes, poor formability and joint forming ability, high welding consumables' costs
   Electrocoated zinc-nickel products painted on both sides with an aluminum rich epoxy:
Disadvantages: The epoxy is hard, brittle, prone to cracking and disbonding, road debris striking fuel tank causes severe cracking and disbonding leading to exposing metal to corrosion Galvanneal (zinc-iron alloy coated steel):
Advantages: Effective for resisting corrosion on both the inside and outside surface of the tank.
Disadvantages: Will not stop hydrocarbon permeation, leakage, pinholes, cracks and voids caused by soldering, brazing, spot welding, seam welding, stickwelding, tig welding or mig welding processes used to attach spouts, valves and other attachments to the container; very high cost of inspecting, hydrotesting, etc.

A seam welding process that does not use filler metal, results in surface irregularities. Other welding processes with cleaning additives in the filler materials would be useful to eliminate some of the pinholes, voids, porosity, etc. Hydrocarbon fuel vapors otherwise will permeate through such pinholes, voids and cracks in the seam weld zone area. Weld inspections of every fuel tank or hydro-gas sniffer tests are very costly. Other welding processes are slow in production and require expensive filler materials.

An additional advantage of the present invention is the substantial elimination of voids in the sprayed coating formed by the momentum of impact from the velocity sprayed powder particles. Adsorption of water within thermal sprayed powder coatings is hence avoided by the elimination of free volume voids. The free volume in conventional coatings results from random residual voids left by the evaporation of solvents, the condensation of coatings, the condensation chain extensions of oligomers within the coatings, metal welding problems as described above, or the cross-linkage of the coating components.

The HVIF thermoplastic thermospray process of the present invention can solve several major problems in the fabrication of fuel tanks so that tanks made by this process can successfully and consistently meet the requirements for low permeability containers.

Other Technologies

Other technologies such as platelet additives in the polyethylene can also be used to create a low permeation wall structure. However, given the lack of a chemical bonding between multi-layer non-compatible thermoplastic polymers of fittings (of HDPE EVOH regrind, etc.) used for welded connections in the containers, the low permeation characteristics of the resulting containers are substantially compromised when pinch welding seams. Further, a plastic weld zone produced under pressure by hot plate technology without the use of fillers has little if any chemical bonding. This multi technology also offers very little if any chemical bonding in the blow molding or the twin sheet thermoformed and blow molded techniques.

Other technologies, such as an electro-coated zinc nickel product painted on both sides with an aluminum rich epoxy, or with platelet additives in thermoplastic or thermoset epoxy resins, can also be used to create a lower permeation wall barrier structure. However, the low permeation characteristics of the resulting containers are compromised when fittings and seam welds are connected to the containers.

Corrosion Control

Conventional corrosion control or prevention coatings for metallic substrates typically use polar polymers in order to enhance adhesion to the substrate. However, the polar bonds represent a weakness in the coating by potentially allowing adsorption and transport of water and dissolved ions to the substrate and consequent corrosion of the substrate. Water, being a polar molecule, has an affinity for other polar molecules, including polar polymers, additives, and substrates, but has no affinity for non-polar polymers. Accordingly, the non-polar materials in the coatings of the present invention act to prevent water and dissolved ions from being absorbed into or percolated through the coating and/or coating/substrate interface thereby deteriorating and corroding of the substrate.

Another aspect of the present invention is the prevention of non-polar polymers, additives and fillers from being polarized by oxidation during the high temperature thermal spray, plasma spray, or subsequent cure of the coating. In accordance with the teachings of the invention, oxidation may be prevented first by use at one or more locations along the thermal spray route of at least one shielding gas, at least one reducing gas, or a combination of the two types of gases to capture or preferentially react with ambient oxygen or residual oxy/fuel thermal spray oxygen.

Anti-Foulant Applications

These coatings are particularly beneficial in anti-foulant applications. Therefore the present invention is broadly concerned with a Novel Anti-foulant Coating for Marine Surfaces and a novel method for applying the coating[s] to surfaces.

All antifoulant paints in use today are effective because toxic ingredients based on heavy metals are included in their formula. The steady accumulation of these metals in the marine environment has adversely affected marine life and caused restrictions on the use of tin-based antifoulant paints. For as long as man has built and operated ships, he has applied various treatments to his underwater structures to keep them free from marine life. Diverse species of hard and soft fouling organisms form colonies on hulls because each requires a permanent anchorage in order to mature and reproduce. Marine growth fouling adds weight to a ship, increases the amount of fuel consumed, and reduces its speed. The sailor ideal is a hull, which never becomes fouled and never requires cleaning or re-coating. Protection against ship hull marine fouling organisms is essential for efficient fleet operation and energy conservation.

To achieve this protection, ship hulls have been coated with antifoulant paints. The paints are very porous and easily wetted through moisture absorption. This is needed in order to activate foulant organism toxic materials—such as cuprous oxide, copper, or organo-tin—by way of release into the water. Conventional antifoulant paint is applied by brush, roller or spray. These methods create an environmental hazard due to high VOC release and a breathing hazard to the people applying the paint given the continuous release of excessive amounts of toxic materials. At present the standard antifoulant coating for the US Navy consists of cuprous oxide dispensed in a mixture of natural resin (highly wetting) and a vinyl chloride/vinyl acetate copolymer. This coating has a service life of at best 12 to 18 months. It is not clear how long the use of fast releasing high volume antifoulant coatings will be permitted to continue in view of the accumulation of copper and tin in the environment. A cruiser size ship (35,000 ft. hull area) releases approximately 2 lbs. of copper/day, an amount that may raise approximately 5 million gallons of seawater to toxic copper concentrations. Dozens of ships painted with conventional toxic antifoulant paint, therefore, can make a significant environmental impact in an enclosed harbor.

State and Federal Environmental agencies are reluctant to issue new building permits for boat dock slips and marinas because of the continuous threat to the environment. Additionally ships coated with antifoulant paint and docked for extended periods of time must be occasionally under water blasted or dry docked. The clean up and reclamation cost of removing media to protect the work areas and waters from debris is substantial. Further, these porous conventional antifoulant paints do not protect steel or vessels from corrosion. When paint is exhausted and the undercoat is worn away, metal oxides are formed and both metal and fiberglass are subject to boat pox or blisters where water penetrates gel coat surfaces and water moisture impregnates the fiberglass causing unsightly blisters and additional weight from the water impregnation. Conventional antifoulant paints doe not provide water barrier to gel coat or fiberglass structures; coal tar epoxy barriers and/or other epoxy coatings are required. Most high performance water barrier coatings, however, resist bonding to antifoulant paints.

Developed in 1989, the history of the Marinelon Composition (Patent: Larry G. Weidman—U.S. Pat. No. 5,041,713, Aug. 20, 1991) shows that in South Florida waters the composition does foul when the vessel is in wet dock for a few days. On the other hand, all of the marine growth does slough off when the vessel moves through the water at a relative slow speed. Furthermore, the hull coating can be high pressure water blasted (under 100 psi) without hazardous discharge of elemental antifoulants. The composition has been found to be a coating resistant to polluting, not a toxin releasing hull coating that is typical of conventional antifoulant self polished abradable paint.

During the 80's and 90' the US Navy and the Marine industry did not accept this new technology due to unknown and unproven performance history and the new application process. The prevailing attitude was “if you can't paint it on with a brush or roller, we don't want it”. The other complaints were that if the composition lasts longer than 3 years, marine maintenance and shipyards would lose revenue and that the equipment was too costly and high tech. Today, the US Navy operates in American and foreign waters and must comply with Federal, State and Local environment regulations plus those imposed by host countries. The US Navy has now made a strong commitment to develop and maintain environmentally sound ships for the 21^{st} century.

The Marinelon Polyamide antifoulant composition and Plasma Gun Process have substantial unsolved problems. The heat, efficiency, enthalpy drop, dwell time (speed) of powder heating, melting range and adjustable regulation bond width, spot size of nozzle, etc. are all important parameters that dictate the chemical composition of the application design criteria. The Marinelon system novel for its time has major difficulties in feeding high volumes of powder, 8 to 10 lbs of powder per hour is its limit. Any more volume will not properly melt producing a very amorphous coating. If high levels of electrical power are programmed the thermoplastic polyamide powders will overheat. The fixed external powder feed injector is downstream 6 to 8″ from the exit of the cathode nozzle. Hence the powder dwell time is not long enough since increased KW power also increases velocity. The ratio of particle heating and dwell time to plasma gas temperature and speed is a narrow window of programmable control. With high power settings and/or higher volumes of powder, the gas speed increases and the powder is overheated.

The Plasma system provides a low volume of shielding gas and is injected ahead of the anode cathode electric power arc. It is mixed with extremely hot plasma gas, providing a superheated atmosphere. However, the opposite is needed for cooling the in-flight molten particles and deposited hot coating. Most Marinelon antifoulant compositions were of a high crystallinity, brittle structure. The hot shielding gas also contributes to the flame extending outside of the gun shroud. The external injections of powder downstream of cathode form a vortex of high-speed gas plume and reduce the deposit efficiency (DE).

The Marinelon process does not properly melt a majority of the injected powders into the heated gas stream resulting in the need for the operator to interrupt feeding. Before spray operation once more starts again, the operator must post-heat the amorphous coating and preheat the surface to a temperature adequate to promote additional melting of powder.

Another disadvantage is that the Marinelon Plasma Process produces very high, dangerous levels of ultraviolet light. The light is shielded by the gun shroud, but still poses a hazard if co-workers or onlookers are in the near area (e.g. within 50 yds. away from process). Protective tent walls and highly restricted work areas were required to prevent people from looking into the bore of the gun and thereby receive severe eye burns.

Yet another problem was found operating the Plasma process in Naval ship yard facilities. Extensive expense was needed to shield water, power, gun cables and other system components to reduce electronic magnetic interference (EMI) and radio magnetic interference (RMI) emissions that caused substantial interference to Naval and Air navigational systems and radio communications.

The Marinelon process and composition result in too heavy of a coating due to the high ratio of cuprous oxide or elemental tin. Marinelon coatings are rough, porous coatings due to the high loading of elemental antifoulants.

In related techniques, some HVOF guns can spray thermoplastic powders to form a film but they overheat and degrade the polymers. The velocities used are reduced to low levels that are linear in levels of heating the gas plume. Most plasma and high velocity thermo spray guns rely on external powder feed injections entering the plume. They produce very low deposit efficiency, DE, of the deposited powder that melts into a film. Most other processes rely on heat input into the substrate to melt the thermoplastic powders by preheated spray powder, by stopping powder feeding, by starting post-heating of deposited polymer to ensure all particles are thoroughly melted and then pre-heating in another area, and by trying not to overheat adjacent deposited spray coating and at the same time spraying more cold powder while post-heating once again. These processes are quite problematic and very slow for large parts or for high production needs. Metallizing thermo spray gun output will not provide porous free coatings that can resist hydrocarbon permeation However the coatings do provide a good resistance to corrosion if applied thickly enough.

Hence, a need exists for an antifoulant thermoplastic composite that is long lasting (8 to 10 yr. protection) and corrosion resistant to protect fiberglass gel coated substrates from water impregnation. Such an antifoulant thermoplastic composite would also need to be low maintenance, wear resistant, non-polluting i.e. no volatile organic compounds (VOC's), abrasion resistant, economical and with low surface energy. A further need exists for an electrically conductive marine coating capable of repelling marine organisms by electronic shock and electronic frequency. A need also exists for laws making mandatory the requirement for such an antifoulant thermoplastic composite to replace the fast leeching, abradable, organo-tin and/or copper oxide antifoulant paint systems that harm the environment. The methods and materials of the present invention meet these needs.

### OBJECTS OF THE INVENTION

It is therefore a principal object of the present invention to provide an improved corrosion resistant coating for substrates, both metallic and non-metallic.

It is also a principal object of the present invention to provide an improved anti-foulant coating for substrates, both metallic and non-metallic. Such a coating would also be low maintenance, wear resistant, non-polluting i.e. no volatile organic compounds (VOC's), abrasion resistant, economical and with low surface energy

It is also a principal object of the present invention to provide an improved electrically conductive anti-foulant coating for substrates, both metallic and non-metallic.

The present invention contemplates applications to new construction, in-mold and field-applied, encompassing electroconductive antifoulant thermoplastic composite coatings enabling application of electrical shock to repel marine organisms.

It is a further object of the present invention to provide improved low permeability containers.

It is a further object of the present invention to provide improved low permeability plastic containers.

It is a further object of the present invention to provide improved low permeability containers made of Steel, such as those used in vehicle fuel tanks. A particular improvement is to be provided in corrosion protection of steel fuel tanks with low permeability fittings and seals coated with a novel thermoplastic composite prepared according to the method of the present invention.

It is a further object of the invention to provide a corrosion resistant coating using non-polar and/or non-polarizable polymers.

It is another object of the invention to provide low-cost corrosion resistant polymer coatings.

It is another object of the invention to provide void-free corrosion resistant polymer coatings for metallic substrates and a method for applying such void-free coatings.

It is a further object of the invention to provide an improved method for applying corrosion resistant polymer coatings without oxidation of the polymer.

It is a further object of this invention to provide a safer method of applying the polymer coatings disclosed herein.

It is another object of the invention to provide an improved device to implement shielding with shielding and/or reducing gases for high velocity, high temperature thermal spray processes.

It is yet another object of the invention to provide a device, gases, and methods for shielding the powder from oxidation during the spray process.

These and other objects of the invention will become apparent as the detailed description of representative embodiments proceeds.

### SUMMARY OF THE INVENTION

In accordance with the foregoing principles and objects of the present invention, corrosion resistant non-polar polymer coatings and a method for applying these coatings to substrates is described. A source of non-polar polymer powder is deposited as a coating onto the surface of a substrate by high temperature thermal spray. The non-polar character of the powder and any additives thereto is substantially preserved during the high temperature thermal spray by introduction at one or more locations along the thermal spray route of at least one non-oxidizing shielding gas, at least one reducing gas, or a combination of the two types of gases to displace or react with ambient oxygen.

These coatings are particularly beneficial in anti-foulant applications. Therefore the present invention is broadly concerned with a Novel Anti-foulant Coating for Marine Surfaces and a novel method for applying the coating[s] to surfaces.

In further embodiments, the inventive coatings are applicable in a novel method of thermoplastic coating ship hulls. A mix of poly-tetrafluoro-ethylene Abcite (Suryln) thermoplastic resin, biologically active additives, and copper/silver clad nano-sized mica flakes is formulated. Then the molecules are embedded into the surface of pure polymeric indomer thermoplastic by heating the compounds into a polymeric composite. The method yields a non-abradable, non-polluting, and long-lasting, marine growth resistant coating that provides low surface energy and high release energy of marine organisms.

In other embodiments, the compositions of the invention advantageously includes a predominant amount of an Indomer with a poly-tetrafluoro-ethylene thermoplastic HVIF heat blending alloy to form a composite resin. Biologically active additives, Sea Nine biocide and nano-sized silver/copper or nickel/copper or cuprous oxide clad mica flake are also alloyed into the composite.

The composition is applied by the HVIF/HVOF process, U.S. Pat. No. 5,285,967, date of issue Feb. 15, 1994. A high velocity, oxygen fuel (HVOF) Thermal Spray Gun is used for spraying a melted powder composition of, for example, thermoplastic compounds, thermoplastic/metallic composites or thermoplastic/ceramic composites onto a substrate to form a coating thereon. The Gun includes HVOF flame generator for providing an HVOF gas stream to a fluid cooled nozzle, a portion of the gas stream is diverted for preheating the powder, with the preheated powder being injected into the main gas stream at a down stream location within the nozzle. Forced air and vacuum sources are provided in a shroud circumferentially around the nozzle for cooling the melted powder in flight before deposition onto the substrate.

To overcome container leakage problems, the present invention provides a thick layer of PVDF chemically bonded to HDPE. The HVIF sprayed on film of 0.020″ to 0.030″ thickness applied to HDPE and the twin sheet in a thermoforming process provides a chemically bonded, homogeneous structure with bonding of PVDF to PVDF and HDPE to HDPE in the pinch zone. An additional HVIF thermospray overlay can be applied to the pinch areas around stubs for extra protection against hydrocarbon permeations.

The extra thick film sprayed into the seal cavity with a mating seal configuration provides a permanent, chemically bonded or ring type seal when the half shells are reheated together in a twin sheet thermoforming process. As a result, the present invention provides a low permeation of hydrocarbon in the pinch zone area. (e.g. see below, 0.1 9 g./24 h). The reheating forming process can utilize hydraulic ram fixtures to push the half shells together. A mini-plasma torch laser and/or seam welder roller can be used to transfer high enough heat (approx. 350 d. F to 400 d. F. and without any filler material) through the two steel surfaces to remelt the thermoplastic in order to form a seal around the perimeter in the proper seal geometrical design.

Fittings and attachments can be attached to the half shells after the sheets are thermoformed and heated. The flanges fitting to mating surfaces are HVIF welded to the container inner wall and o.d. welded to the outer wall and/or attachments.

The half sheets can be pinch welded together with fuel components assembled inside the vessel and HVIF spray welded to pinch around fittings, flanges, etc. without damaging internal fuel components such as fuel pumps, liners, valves, fuel level gauging devices, etc.

The present invention also solves or substantially reduces the problems found in corrosion resistant polymer coatings of the prior art through the use of non-polar and preferably also non-polarizable polymer powders deposited by an high temperature thermal impact energy spray or by a plasma spray process as coatings for corrosion protection of metallic substrates. High temperature is considered herein to mean a temperature at which oxidation of the polymer may occur. Water, being a polar molecule, has an affinity for other polar molecules, including polar polymers, additives, and substrates, but has no affinity for non-polar polymers. Accordingly, the non-polar materials in the coatings of the invention act to prevent water and dissolved ions from being absorbed into or percolated through the coating and/or coating/substrate interface thereby deteriorating and corroding the substrate. Since non-polar polymers do not usually adhere well to most substrates, the surface of the substrate may need to be roughened, such as by mechanical roughening (abrasion, sanding or the like) or by applying a semi-molten metal fiber or particle layer to the substrate prior to coating. The invention is further enhanced if the metal is a less corrosion prone version of the substrate metal to be protected.

Another aspect of the present invention is the prevention of non-polar polymers, additives and fillers from being polarized by oxidation during the high temperature thermal spray, plasma spray, or subsequent cure of the coating. In accordance with the teachings of the invention, oxidation may be prevented by use at one or more locations along the thermal spray path of at least one shielding gas, at least one reducing gas, or a combination of the two types of gases to capture or preferentially react with ambient oxygen or residual oxy/fuel thermal spray oxygen.

An additional advantage of the present invention is the substantial elimination of voids in the sprayed coating formed from the momentum of impact of the velocity sprayed powder particles. Adsorption of water within thermal sprayed powder coatings is hence avoided by the elimination of free volume voids.

### DESCRIPTION OF THE DRAWINGS

The invention will be more clearly understood from the following detailed description of representative embodiments thereof read in conjunction with the accompanying drawings wherein:

FIG. 1 is a schematic illustration in a sectional view of the undercutting of a polar polymer coating by water absorption and migration;

FIG. 2 shows a sectional view of a non-polar polymer coating deposited on a substrate in accordance with the invention and illustrating water beading on the coating without absorption;

FIG. 3 is a schematic sectional view of a non-polar polymer coating of the invention applied over a substrate having a particulate layer first applied thereon;

FIG. 4 shows schematically in axial section a thermal spray device useful in the application of polymer powder spray with the insertion of reducing and shielding gases to prevent oxidation and polarization in the polymer during coating of a substrate according to the invention; and

FIG. 5 is a schematic illustration in axial section of a thermal spray device useful in the application of polymer powder spray with the insertion of excess reducing gas in the combustion chamber, and insertion of reducing and/or shielding gases along the thermal spray direction for preventing oxidation and polarization of the polymer powder in the spray.

### DETAILED DESCRIPTION OF THE PREFERRED EMBODIMENTS

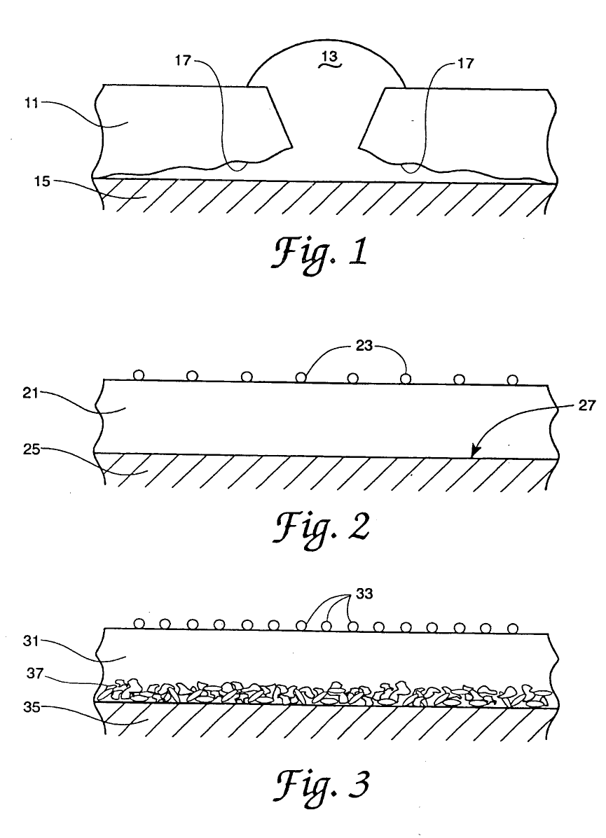

Referring now to FIG. 1, shown therein is an illustration of the detachment of a polar polymer from the substrate by way of acid/base substitutions and/or chemical degradation, such as from a saponification process of a polar polymer coating. Rapid further subsequent migration, absorption and undercutting of the coating by water and/or its contained chemical ions is driven by the accompanying oxygen starvation and increased galvanic corrosion potential cell activity. Contact of the polar polymer coating 11 with water 13 and its contained ions can result in the degradation of the polymer which may result in eventual contact of the water 13 and its contained ions with substrate 15 leading to undercutting and separation 17 of coating 11 from substrate 15. Severe corrosion of substrate 15 by water and its contained ions may then result. Water 13 with sufficient ion content at high enough pH could chemically degrade the polymer coating 11.

Referring now to FIG. 2, shown therein is an example non-polar polymer coating 21 applied to substrate 25 according to the invention. Water 23, being a polar molecule, in contact with coating 21 beads up on the non-polar polymer without absorption into the polymer given that the polymer contains only non-polar covalent bonds thereby providing resistance to polar chemicals as well as prevention of moisture absorption and percolation. In accordance therefore with a principal feature of the invention, coating 21 of the invention comprises a non-polar or non-polarizable polymer that may be applied to a substrate 25 according to methods suggested herein below. Polymers that may be used in the practice of the present invention in order to obtain a corrosion resistant coating for a substrate may therefore be selected from polymer materials including thermoplastic type polymers such as ultra-high molecular weight polyethylene (UMPE), polyethylene, high density polyethylene, polypropylene, nylon, polytetrafluoroethylene (TEFLON), polyvinyl-chloride, polybutylene, tar, wax, latex, polyvinylidene chloride, and other flowable powders including, but not limited to, the pure and non-polar polymers and copolymers of acrylic, polycarbonate, polyaramid (KEVLAR), polysulfone, polyimide, polymethylmethacrylate, cellulose acetate, polyurethane, phenolics, nitrophenolics, polyetheretherketone (PEEK), phenol-formaldehyde, polystyrene, acrylonitrile butadiene styrene (ABS), and nylon, and including thermoset polymers such as acrylic, polycarbonate, polyaramid (KEVLAR), polysulfone, polyimide, polymethylmethacrylate, polyester, epoxy, vinyl ester, polyurethane, phenolic, styrene butadiene (SBR), silicone, polyimide, polyurea, and nitrophenolics. Although powder size range is not critical to the process described herein, the preferred size range for polymer powders useful in the practice of the invention may be from about 1 to about 250 microns. Non-polar or non-polarizable additives to the selected polymer (for example, for purposes of flow control or crystallinity control within the polymer) may include pigments and beads based on polypropylene, polyethylene, Nylon 12, polyvinyl chloride (PVC), TEFLON, and pigments with surfaces treated to prevent water absorption or penetration with, for example, stearic acid, silanes, silicon, cross-linked barrier films such as parylene (polyparaxylylene), or other similar materials occurring to one skilled in the applicable art guided by these teachings. These surface treatments may also enhance water repellency and consequently improve the corrosion resistance of the polymer coating.

Filler Material

The optimized thermoplastic powder is a precipitated round particle rather than a ground jagged particle. Precipitated particles provide easy air classification and screening and permit easy and simple processing. The optimum particle size for high velocity thermospraying is 20 to 100 micron with an overall average of over 60% of the particles averaging 50 microns. The removal of large particles eliminates the possibility of unmelted particles in the film. The removal of fine particles eliminates overheating or burning. The in-flight melt dwell time is a matter of milliseconds.

The heating and mixing of said compositions processed through the HVIF System result in chemically bonded polymer chains with few free radicals. The present invention provides better control in preventing indirect environmental consequences during the use of known, highly effective substances by the elimination of the conventional, abradable high VOC, liquid antifoulant compositions dispersed in typical paint systems. After processing through the HVIF Gun, the present invention composition powder contains and releases no VOC's. Thermoplastic matrix provides resistance to marine organisms based on the physical surface phenomenon of low surface energy and at the same time based on very low level controlled release and depletion of the active substance(s) due to limiting molecular-orientation.

Sea-Nine 211 antifoulant agent is a rapidly biodegradable settlement inhibitor. It is used in a moisture retention formulation combined into an Indomer thermoplastic composite for HVIF processing. It is biodegradable and highly effective at controlling a wide range of fouling organisms while causing no adverse effects on the environment even at higher concentration levels within the composition matrix of Indomer and/or other moisture absorbing thermoplastic resins. A major goal of HVIF applications is in producing non-polluting, fouling resistant, low fouling release, marine hull coatings through the inclusion of low surface energy of surface oriented additives, biodegradable micro-balls biocide, copper/nickel, cuprous oxide, copper/silver clad mica flake, and/or polytetrafluoroethylene compounds into an Abcite (Suryln) thermoplastic matrix.

Use of the HVIF thermospray equipment (no VOC's) and process produces a chemically bonded homogeneous structure. These ingredients are selected and mixed so that the composition, when processed, will provide a marine growth resistant coating that is very low friction, long lasting (5 to 10 year), wear resistant, and environmentally safe. Advantageously, this resistant protective coating has an antifoulant release rate of less than 1 microgram per day, thereby minimizing environmental pollution while maintaining a protective coating against marine growth. Therefore, the composition of the invention can be used effectively to protect ship hulls by providing very low surface free energies with which marine growth is repelled without the adverse release of antifoulant into the water.

Additionally, the present invention contemplates the application of Abcite R (Suryln R) in particularly preferred forms. The composition of the invention includes Polyetrafluoroethylene compounds bound through melt processing to Indomer; however, other forms of thermoplastic are of use as a biodegradable antifoulant agent. Biocidal silver/copper, copper/nickel, cuprous oxide clad mica flakes find utility in the invention. In yet another embodiment, the composition of the invention may include a portion of flake, granular and dendritic powders. In a further embodiment, the composition of the invention may include copper-silver coated glass fiber, glass grains and hollow micro-hollows. These lightweight conductive media are a cost effective alternative to heavy copper or tin antifoulants. Of particular benefit to the present invention is the use of a high aspect ratio of size that enables an intimate particle contact resulting in low loading, advantageous antifouling properties, and excellent conductivity.

In an alternative embodiment, the present invention contemplates the application of precipitated thermoplastic particles coated with copper or copper/silver. Further, the HVIF process of the present invention can provide a melt of these particles with a mixed bonded chain composition.

The mixing and blending of Indomer with Polytetrafluorethylene compounds through the HVIF process forms an alloy polymer that is an homogeneous thermoplastic polymer and Polytetrafluoroethylene composite. The molecular orientation of the various additives provides good release properties and low glass transition values. HVIF process temperature produces semi-crystalline surfaces and optimizes the orientation for minimum surface free energy and maximum performance in repelling marine organisms found in the sea water environment.

In another embodiment, the present invention contemplates use of the HVIF application process to form a dielectric thermoplastic polymer undercoat to protect from electrolysis a second coat of conductive thermoplastic compound containing silver coated nickel clad tubesand platelets. Alternatively, nickel graphite multidirectional woven fabric can be bonded to the sprayed molten thermoplastic polymer. Both methods form a highly conductive coating providing shielding against RMI and EMI as well as integral electrical conductivity allowing the use of low level, non-lethal, electrical energy to repel marine animals. Further, these applications of electro-conductive, electrically isolated, thermoplastic coatings allow for actuation by electrical energy to apply heating to the coatings for deicing applications.

In addition to the aforementioned advantages, the coating has low friction and as a result reduces the noise, drag, and energy needs of the ship as it moves through the water. Subsequent coatings can be applied onto the existing thermoplastic coating without a sacrifice in bond strength. New coatings can be applied without necessitating the removal of previous, exhausted thermoplastic coatings. In one embodiment of the present invention, an antifoulant-free thermoplastic coating is applied prior to the application of the inventive thermoplastic antifoulant composite coating onto marine vessels.

A further embodiment of the present invention contemplates providing an HVIF processed alloy coating composition containing no abradable elemental pollutants. The invention contemplates the use of biodegradable, biologically activated additives using the aforementioned Indomer/Polytetrafluoroethylene polymer matrix thereby producing a non-polluting, biodegradable, antifouling, hull coating.

It is noted that non-polar polymers do not adhere to metallic substrates as well as polar polymers do. Accordingly, in the application of polymer coatings to metal substrates according to the invention, it is preferred that the substrate surface 27 [FIG. 2] first be cleaned by any suitable process known in the applicable art. Then surface 27 may be roughened, such as by mechanical roughening, prior to the application of the polymer coating. Roughness to approximately 0.002 inch average was found sufficient for satisfactory adherence of polymer coating 21 to substrate 25.

Alternatively, as suggested in FIG. 3 roughened surface on substrate 35 may be provided in the form of a layer 37 of metal fibers and/or particles applied to the surface of substrate 35 by any suitable means known in the art, such as by thermal or arc plasma spraying. The application of a non-polar or non-polarizable polymer coating 31 over layer 37 as suggested in FIG. 3 will result in polymer penetration into and mechanical interlocking with the rough surface of layer 37. Polymer layer 31 adheres to metal substrates to which the polymer might otherwise not satisfactorily adhere, and is resistant to penetration from water 33. A sprayed metallic layer 37 may also provide galvanic protection to the substrate. Substrates 25 and 35 may optionally be heated during the spraying process by process compatible means (not shown) in order to prevent premature cooling of the applied polymer coating.

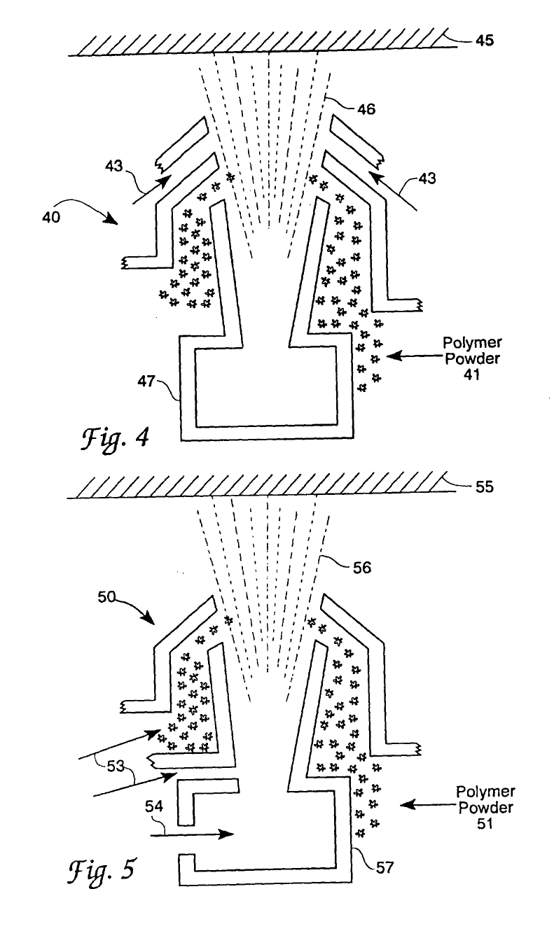

FIG. 4 is a schematic illustration in axial section of thermal spray device 40 useful in the application of polymer powder spray 41 with the insertion of reducing and/or shielding gases 43 along the spray path in order to prevent oxidation and polarization in the non-polar or non-polarizable polymer being used as well as in any additives and fillers used during the thermal spray coating of substrate 45 in accordance with the present invention. In the operation of device 40, a high velocity spray 46 originates within combustion chamber 47. Spray device 40 may be in the form of high or low velocity thermal spray gun, plasma spray gun, fluidized bed, electrostatic spray gun, or other device suitable for applying the desired coating.

Application of the high temperature polymer powder spray may best be accomplished utilizing commercially available high-velocity thermal spray equipment manufactured by Weidman Inc., Fort Myers, Fla. Combustion chamber 47 may be of any suitable type for the intended purpose, such as metal or ceramic. The device can be fueled by propylene, propane, methane, natural gas, acetylene, or hydrogen. The operating temperature for the thermal spray device 40 is typically in the range of from about 200 to 1,500.degree. F. (preferably about 1,000.degree. F.). The high velocity spray is typically applied at about 10 to 900 miles per hour (mph), preferably about 700 mph.

The HVIF TM Gun Combustion Chamber and Nozzle configurations produce a high velocity gas stream that is regulated for the correct processing temperature for a given thermoplastic polymer powder. The powdered particles are internally injected into a pre-heater in the nozzle and then internally injected into the hot gas stream. The particles become fully molten in flight and strike the substrate with enough pressure to splat (form a puddle of molten material) on the thermoplastic substrate. Surface tension in the melted uppermost surface zone area of the thoroughly melted thermoplastic particles behaves like a liquid in which the individual splats or puddles combine, thus producing a fully homogenous film welded to the thermoplastic substrate. There is a mixing and stirring effect that takes place in the fusion zone surface area enabling such a welding. The mixing of both substrate material and filler material allows for some chemical bonding resulting in intermixed polymer chain extensions. The specially designed HVIF equipment gun and components are uniquely designed for spray welding of resins. Other general thermospray processes would overheat both the powder and the thermoplastic substrates.

Oxidation of the sprayed materials within thermal spray 46 may be avoided using a mixture of shielding and reducing gases 43 at substantially any location or combination of locations along the direction of thermal spray 46 between combustion chamber 47 and substrate 45. For example, in FIG. 5 thermal spray device 50 useful in the application of polymer powder 51 spray provides for the addition of excess reducing gas 54 in combustion chamber 57. In addition, there is insertion of reducing and/or shielding gases 53 at one or more locations along the thermal spray 56 direction, including insertion with polymer powder 51. Any suitable shielding gas or reducing gas may be used as might occur to the skilled artisan as appropriate for the intended purpose.

Examples of useful shielding gases include carbon dioxide, nitrogen, argon, helium, krypton, carbon monoxide, and neon. Examples of useful reducing gases include hydrogen, methane, ethane, propane, butane, pentane, hexane, heptane, octane, nonane, decane, alcohols, acetylene, propylene, ethylene, butylene, pentylene, hexylene, heptylene, octylene and hydrogen sulfide. Any selected mixture of suitable shielding and reducing gases can also be used.

A preferred gas mixture used in demonstration of the present invention was 90% nitrogen and 10% hydrogen. Tests using this mixture with UMPE on a high velocity, thermal spray machine showed a three-fold increase in corrosion resistance lifetime of a deposited polymer coating in a salt spray test chamber as compared to a coating applied without protective gas.

Special Nozzles for the HVIF System

Novel nozzles are provided herewith to perform the same functions that are described in Weidman U.S. Pat. No. 5,285,967 High Velocity thermo Spray Guns for spraying plastic coatings. The new configurations are designed primarily for spraying thermoplastics specific to several special applications. One of the nozzles for welding thermoplastic can provide ⅛″, ¼″ and ½″ spray pattern spot sizes. The spray distance, end of nozzle to substrate, is also taken into consideration. The welding nozzle provides for evenly melting of thermoplastic powdered particles, typically 20 to 100 micron in average size, preferably in the about 50 micron range. For some homogeneous filler materials the velocities are reduced by the use of small bore welding nozzles. The plume shape spot size provides a tight beam for welding J prep, V prep, etc. It is particularly useful in welding two pieces of thermoplastic pipe or sheet and for welding attachments onto thermoplastic or thermoset materials in vessel welding.

These novel nozzles are coated with high temperature polyamide polymer on the inside of the powder feed injector ports. An electroplated polyamide emid nickelcoating provides a very smooth-surfaced passageway by coating the entire surface area of the nozzle both inside and out. The coating provides a high heat resistance and slick coatings inside powder feed ports thereby reducing the adverse preplastification effect on the thermoplastic powder that causes sticking of powder to the inside wells of feed ports.

Care is taken that all copper surfaces of the nozzle are coated. The coating provides excellent mold release properties in addition to improved resistance to powder particles sticking to the nozzle injector and in the i.d. of the nozzle, particularly in the mixing area of gas and powder zone and in the exit area at the end of the nozzle. The coating also resists weld thermoplastic splatter.

Gun Nozzle & Modifications

The welding nozzles are primarily straight bore. The powder injection path and the preheated passage are the same. Special o rings grooves and o rings have been added in the powder injection area where the two injection tubes mate to the nozzle. The o ring provides a good seal when the powder feed tubes are inserted into the nozzle. This configuration overcomes earlier problems with some escaping powder becoming trapped between the two o ring seals mating the water jacket to the nozzle. The o ring design allows a squeeze configuration when the powder feed tube o.d. surface is inserted through the o ring seal.

The Gun Shroud Configuration and Inter Venturi Chamber that is inserted into the gun shroud are size matched to the nozzle plume size. All configurations are the same as described in U.S. Pat. No. 5,285,967, incorporated here in its entirety by reference. The venturi shroud is also coated with the special polyamide emid nickel coating to resist stray molten particles or weld splatter from sticking onto the surface.

Pre-Plastifilcation

A portion of the gas stream is divided for preheating the powder. Given many problems caused by high-speed gas traveling through the passageways and eroding screws, valves have been eliminated. The size of the passageways (drill size) now determine the amount of high speed gas flow instead of the use of ceramic valve screw settings.

The use of preheated passageways for preheating plastic powder before injection into the internal plume in the nozzle provided excellent processing for thermoplastic and thermoset resins that have a melt processing temperatures above 200 deg. F. Those materials that have melt processing temperatures below 200 deg. F. do not require pre-plastification. Therefore valves are closed or eliminated for nozzles used in processing low temperature melt resins.

Fan Nozzle

Five new fan nozzles have been developed which we will call C-1000-P-1, C-1000-P-2, C-1000-P-4, C-1000-P-5, and C-1000-P-6. The new configuration of these nozzles produces a Fan spray pattern of deposited thermoplastic approx. 8 to 12″ wide and up to about 22 mm thick. The flow of expanding gas with thermoplastic powdered resins is injected into the interior of the nozzle and expanded into a fan spray pattern by being propelled at subsonic and/or supersonic speeds as needed.

The nitrogen carrier gas and powder are injected downstream of the combustion gas nozzle to prevent overheating of the powder. The use of liquid nitrogen as a powder feed gas carrier provides a cooling effect to the propylene and oxygen fuel mixture that is combusted as well as to both the thermoplastic high speed molten thermoplastic particles and the thermoplastic substrate. This allows for the use of lower volumes of fuel gas and oxygen resulting in reduced flow over time [scfh] cost savings.

The fan nozzle spreads the heat input down over a wider surface. The fan nozzle process parameters can be regulated to produce very thin films over thermoplastic and other resin components that provide chemical bonding between the filler sprayed on layer and the interface zone with the thermoplastic substrate. The process parameters can also produce very high spray rates and thick film per one pass by feeding up to 40 lbs. of polymer powder per hour. This high production spray application is primarily implemented for spraying large surface areas over resin based substrates, like HDPE sheets and other thermoset or thermoplastic resin composite structures without overheating or damaging the substrate materials.

Liquid Nitrogen Shielding Gas is also injected circumferentially into the gun chamber providing an inert atmosphere for the in-flight molten polymer particles that strike and splat on the substrate interface and one another under high-speed pressure. The Liquid Nitrogen Shielding Gas also provides a cooling chemical bond zone for the deposited polymeric film layer while it produces a deposited film as the gun is moved or oscillated. This produces a more flexible and less hard film of particular importance when higher performance thermoplastic polymers are applied over substrates with different chemical properties and with different thermal expansion rates.

The fan nozzle geometry configuration transitions from the cylinder shaped combustion chamber exiting to a straight round bore high pressure area to an expanded I.D. bore and then transitioning down stream of the i.d. bore to form a fan shaped nozzle that delivers a fan shaped gas plume. The gas plume is evenly distributed across the cross section width producing even heating. The powder feed injection zone of the internal nozzle wall is combined with the expanding fan shape i.d. configuration upstream of the final exit (end of nozzle exit). The coated injection angles merge at a 23 deg. angle near the end of the nozzle exit. The high speed expansion of the molten particles projects a fan shaped pattern of traveling, in-flight, plastic particles splatting onto the substrate.

In another embodiment the Welding Nozzle is designed for welding thermoplastic preparations for pipes, sheets, etc. of joints and welds with configurations V and LJ, double J, etc. The nozzle delivers a tight gas stream column. The design is the same as the previously described nozzle but smaller, approx. 20 mm in diameter. The thermoplastic powder is injected in the same manner. Smaller gun components are also scaled down which makes the gun smaller and lighter for the welder or personnel operators. The gun shroud extends further downstream for better shielding in order to protect the welding.

Machining Methods

The transition area for the i.d. base is at the fan copper nozzle. A gun is used for drilling straight holes. An EDM boring machinery process is used for removing copper material to form the fan configuration. A programmable milling machine can be programmed to generate the transitioning of shape from straight bore to expanding Fan Shape Geometry with braised plugs and machined to form the 23 deg. transition angle needed for the powder feed ports.

Inventive Method of Making Thermoplastic Fuel Tank

Blow molded fuel tanks of multi-layered EVOH sandwiched between two layers of HDPE are replaced with the following procedure:
1. Blow mold two ½ sheets;
2. HVIF spray one relatively thick film, 0.020 to 0.025″ PVDF-Nylon-12, etc. onto the i.d. of the ½ shells covering all surfaces;
3. Spray the pinch area extra thick.
4. Attach stubs or any other attachments to the ½ shells;
5. Spray weld to join the attachments, vent valves, stubs, etc.
6. Pinch weld two ½ shells together.
7. Spray the i.d. of the pinch area or of the other attachments to seal.
8. Install the related fuel pump assembly, fuel lines, etc.; and
9. Assemble both ½ shells.

The HVIF sprayed on film of 0.020 to 0.030″ thickness is preferably applied to HDPE. The twin sheet thermoforming process provides a chemically bonded, homogeneous structure bonding PVDF to PVDF and HDPE to HDPE in the pinch zone. A further HVIF thermospray overlay can be applied to the pinch areas around stubs for extra protection against hydrocarbon permeations. Other polymers of particular interest include ETFE, FEP, Halar, Teflons, PFA, all being in the family of fluoropolymers

Conductive silver coated hollow microspheres can be added and blended to the HDPE powder and applied with the HVIF System to form electrical conductive coatings welded to tank walls for grounding plastic. This can be particularly useful in the automotive industry where there are needs for electrical grounding and shields insulating against the heat of local sources like an inferior or perforated muffler or tail pipe. Electro-conductive multi-layered nickel, graphite and aluminum fabric can be sprayed onto the plastic fuel tank surfaces covering the entire surface with fabric leaving exposed electrical connections for grounding on a head ring barrier device for plastic vessels. Ground wire; nickel coated graphite multi-directional, random laid or woven cloth; nickel; aluminum foil; etc. can be HVIF sprayed onto HDPE, etc. to create “potted” areas thereby isolating and insulating conductive materials sprayed onto or in attachments welded to the plastic vessels.

The HVIF sprayed, welded film is chemically bonded to the HDPE fuel tank providing a thick barrier superior to the present methods of using adhesives and/or layers joined by a layer of “ridged” polymer and an outer layer of HDPE. Advantages of the present inventive method include reduced material cost, reduced product weight, and reduced tank failures, ruptures, “crashes”, etc. The inclusion of chemical bonding provides for a superior barrier to hydrocarbon permeations in containers fabricated according to the novel method herein described.

Pinch Area I.D.

The PVDF, HVIF film applied to the i.d. pinch area is chemically bonded to the substrate. This results in less chance of delaminations during the pinch squeeze hot plate bonding process. Melting of the chemically bonding barrier onto the HDPE tank will “pinch weld” better with less chance of leaking hydrocarbons. The elimination of up to 7 barrier laminations of EVOH by replacement with the one thick novel layer of PVDF results in higher performance than in vessels with the EVOH resin layers.

Additionally, spray on the o.d. of the pinch area will be applied with HVIF. The PVDF weld overlay will fill all around the seams with a surface weld overlay thickness of 0.020 to 0.025″.

In another embodiment, a newly designed pinch geometry preparation is used to spray thermoplastic filler into a recessed groove to mate with a remelted HVIF sprayed surface to form a permanent seal under hot plate pressure welding. This may be followed up with an additional HVIF sprayed surface weld on the o.d. surface of the pinch area.

Spray on the o.d. of all attachments provides a double seal for both the i.d. and o.d. The spray will blend together with the fuel tank walls. Advantages of these novel plastic fuel tanks include easier recycling than the multi-layered fuel tanks with less sorting of various plastic types required, prevention of adverse polymer type mixing that can ruin recycled polymer batches, and less waste in the molding process.

The HVIF process is estimated to take approximately 1/2 hour longer for the production of the average sized tank than the present processes of blow molding, thermoforming, etc. Although the HVIF Process takes a longer period of time to spray the entire i.d. of the half shells compared to blow molding or thermoforming the multi-layers, the overall process is less costly than the processes using sophisticated blow molding equipment for producing multi-layered products. Further the change to the described HVIF equipment from blow molding equipment is less costly than the change to expensive thermoforming equipment.

Method for Forming a Low Permeation Container Using HVIF Resins Chemically Bonded to Hdpe Sheets and Forming a Permanent Seal at Seams

The following is another embodiment of the inventive method presented herein:
1. The container wall forming material of HDPE sheets, or other appropriate polymeric sheets, is HVIF sprayed with, for example, PVDF at a thickness of 0.020″ to 0.080 thick over the sheets.
2. The HVIF gun is mounted on a gantry robot arm.
3. The sheets are automatically loaded, sprayed and unloaded, ensuring 100% coverage of the HDPE or other polymeric sheets with a chemically bonded PVDF (or other appropriate polymer or composite) weld overlay film.
4. The container wall forming materials are cut to desired width and length for forming a container.
5. Sheets of substrate thermoplastic material coated with HVIF applied polymeric film are loaded into thermoformers at loading stations in a conventional twin sheet thermoforming process system and
6. The loaded sheets are then transferred into an oven for heating.
   One of the most preferred substrates is HDPE. One of the preferred HVIF sprayed polymers is PVDF.

Using the HVIF process of the present invention, a PVDF film chemically bonded to an HDPE sheet provides the following advantages:
1. Metal parts can be coated with thermoplastic and then welded to another thermoplastic substrate.
2. A stronger vessel results from chemically bonded HDPE as compared to sandwiched or glued together layers. The PVDF HDPE fuel tank withstands temperatures extremes in North America from 40 deg. C to 79 deg. C in-tank temperatures. The 79 deg. C temperature not only exceeds the boiling point of the alcohol fuels, but also causes sagging problems in the conventional tank (especially under the weight of a filled tank), a problem eliminated in the PVDF HDPE fuel tank since PVDF has higher insulator temperatures before it softens or sags. Further the extreme cold will create cracking problems in the conventional tank but not in the HDPE-PVDF composite fuel tanks because of the improved strength and temperature extremes tolerance of the PVDF HDPE vessel.
3. HVIF chemically bonded, sprayed PVDF layer on HDPE provides low permeation rates below 0.1 grams/24 h.
4. The lighter gauge fuel tank has reduced weight when compared to the conventional multi-layered fuel tanks. This allows a cost savings for the lesser amount of material used that off-sets the higher cost for PVDF resin.
5. PVDF thermal properties provide higher performance than EVOH. This is most noticeable in injector fuel delivery systems, systems that have become more widely used of late. In these systems, a portion of the unused fuel delivered by the gas pump is returned to the gas tank at “engine hot” temperatures.
6. The HVIF chemically bonded films of PVDF to HDPE outer sheets can be thermoformed without cracking or disconnecting, thereby providing greater resistance to the “engine hot” temperatures.
7. PVDF retards the rise in fuel temperature and reduces fire hazards. It is self extinguishing when flame is removed.
8. Chemically bonded pinch and seam areas are safer in crashes.
9. PVDF HDPE tanks can be recycled more easily than multi-layer tanks.
10. Lastly,

HDPE-PVDF barrier properties provide excellent resistance to the adverse effects of alcohol and alternative fuels.

In another embodiment, this process may spray surface weld films onto multi-layered sheets for use in making multi-layered containers.

In yet another embodiment of a twin sheet forming process of the present invention, the HVIF surface weld overlay of PVDF onto HDPE sheets contains an o ring type male/female set configuration that is machined into the thermoforming half molds. The seal or o ring safety device is implemented in the invention to be the primary protective barrier and the resistant welded seam to be the secondary barrier for the prevention of hydrocarbon permeation. Another approach to improve the permeability characteristics of Steel fuel tank fittings and attachments is the incorporation of an HVIF thermoplastic spray coating process, a process that solves most of the related problems.

In the combination of both approaches, a complementary or second mold half of two male/female seals is heat process pinch welded to join the seams of the half shells together to form a permanent PVDF o ring seal. The two halves may be simultaneously treated and loaded. Once the sheets have reached the proper molding temperature of about 360 degrees to 430 deg. F. the hot thermoplastic sheets are then transferred to the molds in a molding station with inner vessel components and outer vessel components. The sheets are drawn into each mold half by the application of a vacuum. During this process the sheet in the first mold half is drawn against and preferably partially into the passageway of the seal seat. As the sheet is being drawn against and into the mating seat configuration, part of the inner component and part of the outer PVDE molten thermoplastic coating flow into the passageways. This traps the container and forms a re-melted permanent seal. The container wall then has its PVDF barrier chemically bonded to HDPE in between the inner and outer components. The first and second molds are then closed to form a container. Variations in internal air pressure may be used to assist in forming and cooling the container.

Method for Forming a HVIF Thermosprayed Chemically Bonded Seal for Low Permeation Containers

The half sheets or shell blow molded fuel tank can is weld overlayed on the inside surface of the container with PVDF, Nylon 12, Abcite (Suryln), etc. to approx. 1.020 mils thick. The male/female seal is sprayed extra thickly to approx. 0.005 to 0.015 mil thicker than the surface area for i.d. containers. Both half shells are assembled with one another. The male/female seals align and lock the two half shells together. The hot plate pinch weld welds both half sheets together by pressure and heat thus remelting the chemically bonded deposited overlay and squeezing the molten plastic overlay thermoplastic into a permanently fused o ring seal. The excess flashing is removed on the o.d. of pinch area and milled off with V groove preparation. The pinch area o.d. is HVIF weld overlayed to seal any gaps, voids, unmelted EVOH liners, or layers of HDPE. This procedure ensures a chemically bonded seal for HDPF or HDPE/EVOH multi-layered vessels resulting in extremely low permeability containers such as those used in vehicle fuel tanks.

Another embodiment of the present inventive process is directed to the formation of an automotive gas tank fill spout. The outer fitting can be formed of high density polyethylene. High density polyethylene (HDPE) bonds well to polyethylene wall forming materials. High density polyethylene fittings also provide good mechanical retention of connecting parts. However, as HDPE suffers from high permeability to hydrocarbons, in a preferred embodiment the inner fitting component comprises an HVIF sprayed film chemically bonded to the spout o.d. surfaces. A HVIF sprayed film is also spray welded and blended into the I.D. surfaces while simultaneously sprayed on the chemically bonded o.d. surfaces thereby bonding both fuel tank vessel surfaces to the fill spout surface and thusly forming a welded component.

The thermoplastic powder spray is comprised of an acetyl or other thermoplastic polymer or a thermoplastic/thermoset composite polymer having low permeability to hydrocarbons or other fluids stored in the container. High density polyethylene is widely available from numerous commercial sources, such as Exxon, Mobil, Solvay, Phillips, BASF, Fina, etc. The acetyl materials are widely available from numerous commercial sources such as Dupont, Ticona, Degussa, KF Polymers, etc.

### EXAMPLE

### Low Permeation Fuel Tank

In one of the embodiments, a fitting may be attached to a low permeation container to form a low permeation vehicle fuel tank. The inner component may be an acetyl bar, which may house a valve, such as a check valve. The inner component may have an overall length ranging from about 30 mm to about 300 mm, for example 100 mm. It will have an upper cylindrical portion with an outer wall diameter of about 31 mm, for example. There will also be a projection or projections appropriately placed to assist in pushing into the outer component a pre-sprayed, chemically bonded, layer of thermoplastic film fused to the parent wall material. The acetyl bar may also include an inner tank portion that is continuous with the portion that extends through the outer component of the fitting but which has a wider diameter such as a flange. For example in a non-limiting embodiment, the inner cylinder portion of the inner fitting component has an outer diameter of about 35.25 mm and forms approx. 26 mm of the 100 mm length of the inner component of the fitting.

The matching outer component has a height of about 34.5 mm, an inner diameter at 34 mm and an outer wall diameter of about 42 mm. The outer wall has an integral connection flange with a diameter of about 54 mm, a thickness of about 5.5 mm, and a bar on its outer end with a maximum diameter of about 44.5 mm. The bar flange i.d. and o.d. are HVIF sprayed to be chemically bonded to a multi-layered thermoformed material. A portion of the sprayed on overlay film material is opposed to and between the inner and outer components of the fill spout fitting.

Parent Material and Overlay or Weld Film Thickness

The depth of the fitting into which the container wall is to be extended by the inner component and fitting flange dictates the amount of the parent material required. The parent material can be HVIF chemically bonded to a multi-layered substrate or an existing multi-layered vessel with no chemical bonding or spray weld overlay. Generally, for automotive fuel tanks, a parent material thickness for use in a twin sheet thermoforming process will range from about 1 mm to 7 mm, preferably 3 mm to 6 mm for an embodiment and most preferably will be about 4.5 mm for a further embodiment. These dimensions will vary depending upon the demands of the fitting and weld overlay film thickness. The dimensions of the mating surfaces of the fuel tank flange and the interior wall of the fuel tank may be fabricated in the molding process. The configuration should allow a flange protrusion depth and extension into the tank wall of approx. 20 thousandths of an inch, an amount matching the diameter of the flange.

An exemplary multi-layer thermoplastic container forming material may have an outer layer and an inner layer of the fuel tank grade HDPE that can be obtained from commercial sources such as Exxon, Mobil, Solvay, Phillips, BASF, Fin, etc. The adhesive layers (not chemically bonded) may be formed of linear low density polyethylene with maleic anhydride, such as that commercially available from Mitsui and Equistar. Ethylene vinyl alcohol for a barrier layer is commercially available from Evalca and Searus. Other suppliers may have or may develop adequate substitute materials.

HVIF Methods Applied to Steel Containers

HVIF thermoplastic coated steel gas tanks provide a PVDF inner barrier technology that enables steel tank manufacturers to meet more stringent emission standards. The SHED tests are expected to indicate hydrocarbon permeation rates as low as 0.1 g/24 hrs or less. The performance of HVIF thermosprayed PVDF barrier coatings installed on the I.D. of mild steel fuel tanks exceeds that of multi-layered plastic extrusion tanks. The maintenance of desired thermal properties of the chosen material is also an issue, especially due to the proliferation of injector fuel delivery systems in which a portion of the unused fuel delivered by the gas pump is returned to the gas tank at “engine hot” temperatures.

At the same time, the tank must withstand extreme temperatures in North America from −40° C. to 79° C. in-tank temperatures. The 79° C. temperature not only exceeds the boiling point of the alcohol fuels, but also creates sagging problems for plastic (especially under the weight of a filled tank) while the extreme cold introduces potential cracking problems, e.g. in the EVOH pinch area for multi-layered plastic fuel tanks. The inner seal for the steel with HVIF thermoplastic sprayed onto the i.d. of steel fuel tank half shells can be surface heated by a rolling electric welder. The thermoplastic will melt once again to form a leak-proof, permanent, homogenous structure.

When the end prep mild steel areas of mating half shells do not have any thermoplastic in the weld area, welding the two composite half shells will provide excellent permeation of the fuel tank vessel. To correct for this deficit, the o.d. of the fuel tank should be sprayed with PVDF or another less expensive thermoplastic such as HDPE-Nylon-12, Suryln, EVOH, polyester or liquid spray epoxy paint.

The American Iron and Steel Institute reports that a series of more than 75 tests undertaken by the National Fire Prevention Research Foundation and Factory Mutual Research Corporation indicated the plastic containers storing flammable or combustible liquids, in a general purpose warehouse, fail abruptly when exposed to a small fire. This failure results in a rapidly developing spill fire that overpowers conventional sprinkler systems. The same tests conducted with flammable and combustible liquids stored in steel containers resulted in no spill fire, no excess temperatures, no content involvement and no significant loss of visibility due to smoke. The outer layer of thermoplastic composite fuel tanks will burn if fire reaches the overheat and combustion temperature, but the steel inner layer will not burn and will eventually extinguish the fire.

As a result, OEM plastic fuel tank suppliers resort to heavier gauge plastic thereby negating at least some of the weight advantage and must also use support brackets and special shields against the heat of local sources like on an inferior or perforated muffler or tail pipe. High ambient temperatures underneath the car remain a consideration. Thermoplastic steel composite tanks will provide high strength and rigidity under high weight load. The thermoplastic acts as an insulator to retard the rise in fuel temperature. Although the thermoplastic will soften, the steel will not sag in a fire. The thermoplastic will retard rises in the fuel temperature thereby reducing the risk of over-pressurization and eventual release of the fuel through a mechanical fitting.

A special outer coating comprised of Poly-Amide-Imide ceramic or Poly-Amide-Imide filled with 48% aluminum oxide can well withstand extreme temperature and can be sprayed over mild steel or thermoplastic bonded to mild steel with good bonding and without detachment. A first layer of a thermoplastic, highly heat resistant HVIF coating can be sprayed onto the surface areas of steel fuel tanks that are exposed to extreme heat such as from tail pipes and mufflers.

Corrosion

Corrosion is also a well-known concern for both the inside and outside surfaces of steel tanks. The outside surfaces and supporting structures are exposed to road chemicals, salt, mud and gravel. In view of the sacrificial nature of the zinc coated products that replace earlier products such as terne plated products, resolution of the corrosion issue becomes critical. Hence there is an even greater need for the highest quality of the barrier film for both inside and outside surfaces. Thermoplastic coatings produced by the high production HVIF thermoplastic spray system meet this need and offer substantial advantages to steel fuel tanks. This technique lends to considerably improved continuity in the barrier thermoplastic layer at the seam, over attachments and where the stamped mold halves come together. The resultant tank walls have an average thickness of between about 1 mm to 10 mm. Both the outside tank surfaces and the inside tank surfaces made of thermoplastic, homogeneous film coating the steel fuel tank walls are fused and bonded together. Therefore thermoplastic steel and HDPE composite gas tanks are inert to the corrosive environments inside and outside of the tank. Further containers constructed using the HVIF thermoplastic process materials have low permeability to hydrocarbons or other vapors/fluids contained therein.

Mild steel is the preferred steel for use with the novel HVIF coatings described herein for several reasons:
1. It is less expensive than the coated nickel, zinc, and/or tin galvanized, coated steels;
2. Mild steel is easier to weld and does not cause hazardous vapors when used in most welding processes with proper ventilation;
3. Expensive pollution equipment is required when welding zinc aluminum, nickel zinc or tin metals or metallic coatings over mild steel;
4. Mild steel can be easily formed or stamped; and
5. Thermoplastic coated mild steel provides better corrosion resistance through the high performance of stainless steel.

### Tank Example 1

### Stainless Steel, Mild Steel and Aluminum Fuel Tanks

Stainless Steel, Mild Steel and Aluminum substrates were HVIF spray coated with Nylon 12, Dupont Suryln, or PVDF. All of the coated substrates showed high bond strength of at least 3,700 psi on repeatedly performed pull tests. Nylon 12 sprayed onto mild steel tested out best with strength in excess of 4,000 psi on the pull test.

### Tank Example 2

### Grounding, Insulation, and Anti-static Electricity Effects

Plastic acts as an insulator to retard heat transfer to the steel tank and heat transfer to the fuel thereby reducing the risks for fire. In the case of an under car fire the plastic coatings will retard the rise in fuel temperature but they will soften, sag and eventually separate from fuel tank. A thermoplastic HVIF sprayed coating of PVDFwith 48% by weight of mica flake or silica flake resists ignition and performs as a great insulator up to about 2200 degrees F. Without insulation, fuel temperature in steel fuel tanks can rise rapidly, thereby risking over-pressurization and release of fuel through a mechanical fitting. The inventive thermoplastic/ceramic coating prevents such a rapid rise in temperature and extinguishes itself when extreme open flame is removed. Use of this invention and findings can lead to a return to use of steel containers that provide fire safety as well as corrosion protection and low permeability to hydrocarbons.

Comparative Steel Fuel Tank

A typical fuel tank has a common wall stamped half shell with a male/female seat configuration for permanent thermoplastic seal around the inside perimeter of the seam weld area. The tank has a common wall that is penetrated by a fill spout and a sender apparatus. In order to install the spout and the apparatus, it is necessary to cut through the wall so that these fittings can penetrate the container and be brazed to the container walls. The inside thermoplastic coating barrier coating has a masked off area for other uses such as for a seam welding zone or for a brazing and/or welding zone for stubs. Detachment and degradation of conventional thermoplastic coatings allow for failures in these containers, allowing leakage particularly in weld areas and around attachments to the tanks. Use of HVIF applied thermoplastic coatings instead would improve tank life and performance.

The conventional half shell stamped fuel tank can be thermoplastic coated with proper masking off of critical surfaces that can not be coated with a process that requires oven processing of the thermoplastic. One such process would be electrostatic spray powder followed by oven fusing and melting of the powder into a film. Fluidized beds, some ovens to melt powder, Hot Flocking, etc. must be hotter (generally 350 to 600° F.) than the stable powder temperature maximum. The substrate temperature on the upper steel wall should not exceed 210° F. Further, processes that use ovens for melting or reheating thermoplastic powders deposited onto steel parts would severely damage the fuel system components and attachments.

Marine Applications

In preferred production procedures, the powdered compositions in accordance with the present invention are prepared by thoroughly mixing appropriate powdered amounts of the Indomer (Abcite), the porous moisture absorbing thermoplastic, and the antifoulant. Preferably, the powder is prepared by mixing effective amounts of silver copper coated mica, PTFE, Sea Nine and biocide in a Henschel blender at 3200 RPM for 2 minutes, blending this mixture into powder of a size at approximately average of 5 microns.

Preferred techniques for applying the coating composition of the present invention include the steps of:
1. Providing a high velocity oxygen fuel system using appropriate subsonic and/or supersonic gas speeds injecting the powder coating composition into the internal pre-plastification injection zone in the gun nozzle;
2. Melting the powder without overheating the powder;
3. Directing the molten in-flight particles substantially one direction through an cold inert shielding gas and hot gas into an expanded nozzle for minimizing a large spray pattern;
4. Misting a vortex of water at the powder of the composition;
5. Spraying said melted composition onto a surface to be coated;
6. Concurrently circumferentially cooling the surface and molten coating to a semi crystalline state.

Gases useful in this invention include oxygen, propylene, acetylene, hydrogen, liquid nitrogen, compressed nitrogen; argon compressed gas or liquid argon and combinations thereof. The coatings made from the compositions of the present invention, when applied using the present inventive application process and techniques, can be formed with high application rates, densities and chemical bonding to other plastic substrates. Further, these coatings have very high bond strength to metallic substrates, far greater than that of coatings applied by conventional plasma spray thermoplastic applications processes and other processes such as fluidized bed dipping, acetylene oxygen flame spray, and electrostatic powder coating.

In another embodiment, the High Velocity Impact Fusion (HVIF) or HVOF spray method of the present invention may further involve additional electro arc or Corona plasma surface treatments. These treatments are applied as needed to affect the treated surface areas' properties such as of discharge, bend, surface tension (surface treating to raise surface tension) and debris elimination for resin based substrates during spraying of thermoplastic compositions.

In coating a marine surface such as aluminum boat hulls, the hull may first be pre-coated as set forth herein above by application of a dielectric non-filled thermoplastic resin. The resin is melted and then applied to the hull by directing the heated gas stream toward the surface of the hull. The thermoplastic coating thus applied is permitted to melt to form a non-conductive barrier without preheating or post-heating with the gun.

A preferred pre-coat is formed of the dielectric thermoplastic Abcite X60. The pre-coat is then HVIF sprayed with an antifoulant coating mixture including a PTFE silver coated copper mica, Sea-Nine, Vancide-89 and a thermoplastic such as Abcite or Suryln hygroscopic grades. More specifically, the antifoulant coating is injected, as previously described, into the HVIF System Gun in order to melt the antifoulant composite mixture. The melted antifoulant coating mixture is then applied over the barrier coat and allowed to cool thereon, thereby producing a thermoplastic composite coating on the aluminum hull.

In another embodiment, an electro conductive additional coating may also be applied according to the method disclosed herein. Such a coating includes effective amounts of Abcite, or combinations thereof with other (co)polymers, a portion of highly conductive silver copper coated flake, and nickel coated graphite multidirectional (e.g. random laid) fabric that provides a thermoplastic powder resistivity of less than 2 mohms-cm. The silver/copper coated mica flakes in the composition are not melted in the heated gas stream. Neither is the conductive multidirectional fabric melted during the lay up spray process application.

A most preferred thermoplastic resin HVIF Alloy is obtained by pre-melt mixture of a PTFE with Abcite in accordance with the present invention methods. Such a mixture includes approx. 50% Abcite by weight, about 20% by weight Polytetrafluoroethylene, about 12% by weight of Sea-Nine, and about 14% by weight of Silver/Copper clad Mica Flake and about 4% by weight of Vancide-89. This composition is initially in the form of a powder mixture and is dry blended and subsequently heated in the HVIF Thermospray Process to form a blending-mixing-molten state forming a new alloyed composite. The blending/mixing/mllting continues until a thermo dynamically stable state is reached. The composite coating is then ready for application to a marine surface whereupon it forms a dense, impact resistant, very slick coating. The composite is immiscible in aqueous environments. Anti-foulant/biocidal components are released from the coating into the marine environment at a rate of less than 2 micrograms per sq. millimeter of coating per day. In a preferred embodiment, the components released are in the form of biodegradable microballs that rapidly become degraded and non-harmful to the environment.

Another embodiment provides a powdered coating pre-melt mixture comprising:
1. From 40 to 55% by weight of Abcite R,
2. From 10 to 20% by weight of PTFE,
3. From 10 to 30% by weight of Sea Nine,
4. From 2 to 8% by weight of Vancide-89, and
5. From 10 to 37% by weight of nickel, Silver Copper Clad Mika Flake

More generally, one of the embodiments of the present invention uses coating compositions having about 60% by weight of Abcite (Surlyn) and about 30% of Polytetrafluoroethylene and Polytetrafluoroethylene combinations with other polymers. Another preferred composition comprises a total of Abcite and resin of about 40-70% by weight, about 10-30% by weight of antifoulant Sea-Nine combinations, about 10-30% by weight of Silver nickel Copper clad Mica Flake selected from a group of clad ceramic metal coatings and combinations therewith, and about 2-8% by weight of. Biocide selected from a group of antimicrobials and fungicides. Another preferred composition comprises from 40 to 60% by weight of Indomer thermoplastic selected from the group consisting of Abcite (Suryln), and polymer combinations therewith, mixed with from about 10 to 20% by weight of thermoplastic compounds selected from the group consisting of Fluoropolymers, Polytetrafluoroethylene, and polymer compound combinations therewith.

Abcite (also known as Surlyn, Dupont Abcite Surlyn) based resins are inomer class powders made with acid co-polymers selected for desired molecular weight grades. A polymer matrix results from salt formation and acid neutralization of sodium ions, iron clusters, etc. with these co-polymers of, for instance, ethylene/methacrylic acid or the zinc, sodium, lithium or other salts thereof (hence the general term “Ionomer”).

This thermoplastic comes in various grades of powder and has a melting point of 93 C to 100C and a bulk density of 0.41 to 5 g/cc. Abcite is available commercially may be obtained from Dupont polymer powders, Switzerland S.S., under the trade name Abcite.

Ionomer-Surlyn is also available commercially. Surlyn 8660 thermoplastic resin is an advanced ethylene/methacrylic acid (E/MAA) copolymer in which the MAA acid groups have been partially neutralized with sodium ions. The MAA neutralization level is optimal for compounding with high loadings of other aforementioned powdered components such as the PTFE.

This Ionomer also comes in various grades of powder and has a melting point of 192° F. to 212° F., a bulk density of approximately 0.4 to 0.5 g/cc and a true density at 20° C. of approximately 1.04 to 1.12 g/cc. Suryln is available commercially and may be obtained from Dupont, Inc.

Polytetrafluoroethylene is a completely fluorinated polymer manufactured by free radical polymerization of Tetrafluoroethylene with a linear molecular structure of repeating—CF2-CF2 units. A crystalline polymer with a melting point of 327° C. density is 2.13 to 2.19 g/cc. Semi-amorphous PTFE powder of 2 to 4 microns size is processed through HVIF to form an Indomer composite matrix. The physical form of PTFE provides multi-functional usage in the present invention. PTEF is another plastic copolymer matrix and non-stick. This non-stick property acts as an antifoulant (non-stick) resistant to biopolymeric adhesives of marine fouling organisms. PTEF is available commercially and can be purchased from Dupont as Zonyl.

Another suitable antifoulant contemplated by the present invention is Sea Nine antifoulant microbial control compound formula “SEA-NINE 211”, made by Rohm and Hass Co., Ltd.: 4,5-dichloro-2-n-octyl-4-isothiazoline-3-one. Sea Nine antifoulant agent commercially can be purchased from Rohm and Haas, Specialty Chemical Co.

Another suitable antifoulant contemplated by the present invention is the fungicide having a chemical formula name N-Trichloromethylthio-4-Cyclohexene-1.2-Dicarboximide. It is a white powder with a melting range 168-174° C. and an application density at 25° C. of 1.69 mg/sq.m. Available commercially as Vancide 89, it may be obtained from RT Vanderbilt, Norwalk, Conn.

In another embodiment, the present inventive composition comprises electro conductive antifoulant compositions containing silver/nickel coated copper alloy clad to ceramic flakes. The shape has a specification of 0/0 Ag metal-9, power resistivity of 1.3 Mohm-CM, mean particle Size 40 (microns), true density 9.0 g/cc, and Scott apparent density of −8(g/cu. in.).

Another from of the present invention contemplates electro conductive antifoulant compositions or silver/nickel copper alloy clad granular shape powder having a specification of 0/0 Ag metal 17, power resistivity of 0.5 mohm-cm, mean particle size of 45, and Scott apparent density of −40 g/cu.in.

Yet another form contemplates electro conductive antifoulant composite or silver/nickel coated copper alloy clad dendritic shape having specifications of 0/0 Ag metal 18, power resistivity of 0.5 mohm-cm, mean particle size 35(micron), true density 9.2(g/cc), and Scott apparent density −24(g/cu. in.)

Nickel/Silver or copper coated mica (ceramic mineral) flake silver coated glass fiber, silver glass grains, and other inorganic materials in the present invention are used to increase the amounts of antifoulant and electroconductivity which can be carried by the aforementioned composites. Silver coated hollow glass spheres, silver or copper coated hollow glass spheres, Ag clad filament glass clad with thin layer of silver copper or nickel/copper conductive layer, and silver copper coated aluminum particles are especially suited to meet the electromagnetic shielding requirements of MIL-G-83528 for conductive elastomers. Uses of various metal cores such as copper, aluminum and nickel are coated with pure silver, copper and varying mixtures of copper, silver, and nickel combinations are all encompassing within the scope of the present invention. Solid glass spheres, hollow glass spheres, glass fiber, carbon fiber and mica (ceramic) (mineral) flakes are particularly useful forms for use in the present inventive compositions. Desired conductivity, antifoulant, and EMI performance properties are engineered using different cure substrates utilizing different metallized coating ranges. A preferred conductive additive product is purchased from Potter Industries, Inc. Valley Forge, Pa. Examples of additives useful to this end include, but are not limited to, silver nickel or copper clad flakes, granular powder, dendritic forms, graphite nano-tubes, silver,nickel coated glass fiber, silver coated hollow microspheres, copper coated nickel hollow microspheres, and copper coated glass fibers.

In addition, the present invention contemplates providing an electro conductive antifoulant coating by combining the HVIF spraying process of electroconductive antifoulant with multidirectional and/or woven graphite fabric clad with metals selected from nickel, copper, silver and combinations thereof. The multi-directional or woven fabric can be constructed of Nylon-graphite, monofilament, etc. The use of conductive nano-graphite tubes is also contemplated in this invention. Such a nano-tubes thermoplastic composition over fabric or by itself would have a coating thickness of 2-3 mils with a Volume resistance of (10 2 ohm-cm) and a very smooth Class B finish for the electrical connection to the conductive fabric.

Another example of use within the inventive process operation is performed as follows:
1. Spray thermoplastic, free of antifoulant resin onto substrate;
2. When thermoplastic is in a semi molten state, the fabric is applied with a pressure roller to adhere the fabric to the thermoplastic coating;
3. Let the thermoplastic cool to a semi crystalline state;
4. Optionally, a second coat of prepared thermoplastic antifoulant conductive additives can be HVIF sprayed over the substrate using non-reinforced thermoplastic.

During the HVIF spray lay up process the fabric is overlapped to make electronic connection among the integrating electrical wires to be later connected to power supply terminals. A high frequency pulse, very low current is applied to the composite to repel marine organisms (barnacles, zebra mussels, etc.) by non-lethal electric energy and frequency.

Examples of Polymeric Coatings

The following examples demonstrate the preferred preparation of the powdered composition in accordance with the present invention together with typical steps involved in application of the coatings for optimizing low permeability, anti-corrosion, and/or anti-foulant properties. The improved characteristics of these novel polymeric coatings include better fire resistance, excellent bonding between molecules, and good mechanical properties in elongation flexure, tension, compression, and impact resistance as further described below for some of the preferred polymeric coatings. Further, as noted above, a significant additional advantage is realized in the high velocity high temperature application of non-polar polymer coatings in that the momentum of the powder particles striking the substrate results in a substantially void free coating that can preclude the adsorption of water into the coating and consequent corrosion of the substrate.

Thermoplastic Powders

### EXAMPLE 1

### PVF2 Polymeric Coatings

One of the most preferred polymers is PVF2 (Polyvinylidene Fluoride). Ground to 20 to 100 microns with an average of 50 microns the powder provides a very good thermoplastic for the HVIF System. The thermoplastic HVIF applied powder provides a corrosion resistant, protective weld overlay to HDPE or EVOH plastic fuel tank substrates from 0.015 to 0.060 inches in thickness sprayed over pinch areas and seams. The PVF2 provides weld overlay film impermeable to hydrocarbon, alcohols and fuel vapor permeation, and a wide variety of corrosive environments up to 300° F. and in addition has excellent mechanical properties, such as impact resistance.

The usage temperature range for spraying PVF2 over HDPE substrate is from a negative −60° C. (−76° F.) to 170° (338° F.). The HVIF gun process provides a circumferential array of shielding (inert nitrogen gas) during spraying operations that suppresses crystallization in the fusion zone. The layers are predominately amorphous, more flexible and with slightly less surface hardness than semi-crystalline coatings.

Fire Resistance

In actual ASTM D 635 tests, PVF2 polymer does not burn freely and self extinguishes on removal of the flame. It has an oxygen index of 43 (minimum of oxygen, expressed in % of an atmosphere in which burning could occur). Meaning PVF2 will not burn in a normal atmosphere.

PVF2 HVIF Applied Films—Physical Properties

PVF2 has excellent bonding between molecules and shows good mechanical properties in elongation flexure, tension, compression and impact resistance when sprayed over HDPE or EVOH thermoplastic substrates. The tensile yield strength is 575 kg/cm2 (8000 psi), the highest of any of the fluorinated polymers. Pull tests of PVF2 sprayed onto HDPE or EVOH substrates were done with pull at 4000 psi and over without causing disbonding. UV and Gamma radiation stability as well as weathering and aging resistance are excellent. The HVIF applied PVF2 shows good gloss holding capability against ultraviolet radiation. Weatherometer tests indicate no decrease in tensile strength after exposure to ultraviolet radiation for 3000 hours. After exposure to 100 megarads of electromagnetic radiation, PVF2 showed no decrease in tensile strength.

PVF2 Blend w/Ceramic Platelets Reinforcement

PVF2 and approximately 34% to 60% of total weight of flat silica platelets of approximately 130 micron size are blended and sprayed through the HVIF System. Under scanning electron micrograph analysis 15 ku×500, the processed film is shown to have random positioning of platelets suspended in a matrix of PVF2. The platelets overlap one another, approximately 60% lay flat with some off angle platelets or flakes at angles of 15 to 20° off of the surface. Approximately 10% or less are straight in at an angle of 60 to 90°, i.e. nearly perpendicular to surface. The mica or silica platelets offer an additional impermeable barrier to the hydrocarbon fuel vapors. The reinforcement with mica or silica platelets increases the strength, hardness and fire retardant properties to a higher level than ever found for unreinforced PVF2 resin.

Grounding

Special conductive PVF2 blends using metallic powder were sprayed as films over HDPE or EVOH. Silver coated hollow microspheres, flake, etc. with a typical reinforcement content of up to 72% by weight provide a film with good electro-conductive properties. Grounding cables, wires and straps can be attached to the substrate and overlayed with thermoplastic films sprayed through the HVIF System to cover and insulate attachments from electrical current. Fasteners are attached to thermoplastic fuel tanks by spraying a layer of molten thermoplastic coating. Pressure is applied to the attachment placed onto the sprayed overlay. When the resin cools, the attachment is bonded to the tank. Then the HVIF gun applies an overlay to cover the attachments and to cover and blend with the coating already on the fuel tank wall.

Parameter Development

Materials: PVF2 Manufacturer: KF Polymer
Particle Size: 20 to 100 micron—average 50 microns
Color: Clear
   Application Description
HVIF Spray Overlay, blow molded or thermoformed multilayer
HDPE—EVOH Plastic Fuel Tanks

Apply To: Pinch Areas-Attachments and Surface Areas

| | | | | | Cold |
|---|---|---|---|---|---|
| | High | High | | Liquid | Liquid |
| | Pressure | Pressure | Bottles | Nitrogen | Nitrogen |
| Cylinder | Oxygen | Hydrogen | Propylene | Carrier | Shielding |
| Supply | 165 psi | 175 psi | 125 psi | 100 psi | 40 psi |
| Pressure | | | | | |
| Control | 150 psi | 150 psi | 100 psi | 60 psi | 40 psi |
| Supply | | | | | |
| Pressure | | | | | |
| Ignition | 30 scfh | 110 scfh | | | |
| Flow | | | | | |
| Ramp Flow | 400 scfh | 60 scfh | | | |
| Run Flow | 370 scfh | | 60 scfh | 30 scfh | 40 scfh |

| | |
|---|---|
| Forced Air Frequency Setting No. | 35 |
| Vacuum Air Frequency Setting | n/a |
| Nozzle Spot Size | 2″ Round |
| Powder Feed Threshold | 30 psi |
| Canister | 30 psi |
| Powder Feed Lead Screw | RPM 200 |
| Powder Feed-lbs. Per hour | 24-35 approx. |
| Auxiliary Cooling Forced Air Frequency | 35 |
| Setting | |
| Preheat | n/a |
| First Pass-Center of Pinch | 90 degrees straight |
| Second Pass- | 15 degrees bottom of pinch |
| Third Pass- | 15 degrees to of pinch |
| Post Heat | n/a |
| Spray Distance (end of shroud to substrate) | 6-8″ |
| Gun Travel Speed - rpm or ipm | n/a |
| Part Rotation Speed - rpm or ipm | 550 ipm |
| Oscillation Frequency | n/a |
| Oscillation Width | n/a |
| Overlap distance | ½″ approx. (bead |
| | to bead) |
| Oscillation-Indwell-Outdwell-Duration Time | n/a |
| Proximity Control | manual |
| Overlay thickness per one pass | .003 to .005″ |
| Overlay over all thickness | .015 to .020″ approx. |

Surface preparation of excess trim was milled off at approximately 80 thousandths of an inch measured from side walls to top of pinch. Pinch did not overheat. Good coverage was obtained. Corona Electro Arc Plasma Treatment was used to pinch areas 2″ ahead and 2″ after end of the pinch area.

### EXAMPLE 2

### Nylon 12 Polyamide Block

Prepared round particles of nylon-12, air classified and screened to 20 to 80 microns with overall average 50 micron size, provide excellent melt flow (coating behaves like liquid). The melting point of 176 degrees C. enables a favorable processing temperature. Nylon-12 can be used at temperatures considerably less than 0° C. without alteration in properties. Nylon-12 is stable on long term exposure to heat of up to +80° C. and for brief periods can be further heated with damage. In a mechanically unstressed state, Nylon-12 tolerates temperatures up to 160° C. HVIF Thermospray System application of Nylon-12 over pinch areas of plastic fuel tanks provided the following advantages:
1. Impermeability to hydrocarbon and fuel vapors;
2. Adds strength to weak, vulnerable seam pinch areas (crash resistance);
3. Higher performance;
4. Excellent resistance to adverse road sites, debris, abrasion and erosion; and
5. Provides a fusion zone of chemical bonding to HDPE and EVOH.

Parameter Development

| | |
|---|---|
| Material: | Nylon-12-2157 |
| Manufacture: | Degusa |
| Particle Size: | 20 to 80 micron average 50 microns (a precipitated Round |
| | particle) |

Application

Description: HVIF Spray Weld Overlay Films to blow molded Or thermoformed multilayer HDPE-EVOH Plastic Fuel Tanks, Pinch Area, Stubs, Fuel neck Connections, etc.

| | High | High | Liquefied | Liquefied | |
|---|---|---|---|---|---|
| | Pressure | Pressure | Propylene | Nitrogen | Nitrogen |
| Cylinder | Oxygen | Hydrogen | Fuel Gas | Carrier Gas | Shielding |
| | 165 psi | 175 psi | 125 psi | 100 psi | 40 psi |
| Ignition | 30 scfh | 110 scfh | | | |
| Ramp | 400 scfh | 60 scfh | | | |
| Flow | | | | | |
| Run Flow | 270 scfh | N/a | 60 scfh | 30 scfh | 30 scfh |

| | |
|---|---|
| Forced Air Frequency: | RPM no. 35 to gun |
| Nozzle Spot Size: | 2″ Round |
| Powder Feed Threshold | 30 psi |
| Canister Pressure | 30 psi |
| Powder Feed Lead Screw; | rpm 200 - ½″ DIA. |
| Powder lbs. Per hour: | Approx. 24-28 |
| Auxiliary Forced Air | |
| Cooling Frequency | |
| Control Setting: | Y connection 40 trailing air cooling |
| | Jet, spray parameter, pinch area |
| | Only |
| Preheat: | n/a |
| First Pass | center of seam |
| Second Pass | 15 degrees off 90 degrees |
| | Bottom of seam |
| Third Pass | 15 degrees off 90 degrees |
| | Top of seam |
| Fourth Pass | 90 degrees straight on center of seam |
| Post Heat | n/a |
| Spray Distance | 6-8″ |
| Gun Travel Speed | n/a |
| Part Rotational Speed | 550 ipm |
| Oscillation Frequency | n/a |
| Oscillation Width | n/a |
| Oscillation Indwell-Outdwell time | n/a |
| Overlap Distance | Approx. ½″ bead to bead overlap |
| Proximity Control | Manual |
| Overlay Thickness per one pass | .003 to .005″ |
| Overlay Overall Thickness | .020″ approx. |

Surface preparation of excess trim was milled off at approx. 80 thousandths of an inch measuring from sidewalls to top of pinch. Excellent coverage was obtained. Corona Electro Arc Treatment process was performed 1 minute before HVIF spraying was performed. Pinch area did not swell or overheat.

The same parameters were applied to weld overlay stems except for a nozzle change to 22 mm spot size and for use of one pass at reduced 120 rpm powder feed lead screw speed. Coating thickness per one single pass was 0.035 in. of thickness. The tank was positioned on a rotary table to reach the stub location for welding. Pull test results exceed 3700 psi.

### EXAMPLE 3

### Dupont Abcite X 60 X70-Natural Product Code B PC7900 S8000

The X60 processes very well. A chemical bonding between the EVOH and HDPE composite multilayers is seen under electron microscopy. Analysis reveals a blending or mixing dilution zone that is very pronounced. The X60 and X70 must be stored in a dehumidifier room as they pick up moisture and clump. When powder is stored in powder feed canister for a short period of time the cold liquid nitrogen gas dries up the powder and it processes well. Mica and or Silica platelets blended into the Abcite provide an additional protection barrier against hydrocarbon and fuel permeation. The Abcite X60 is very flexible and protects flexibility of the pinch area even when a water filled fuel tank is dropped from 20 ft. high. No cracks or leaks were noted. X60 is a good material as a bonding overlay film, especially when combined with a second layer of Nylon-12 that provides a good barrier against hydrocarbon permeation.

Parameter Development

| | |
|---|---|
| Material | Abcite x 60 and x 70 |
| Natural | Part 51180142 |
| Manufacture | Dupont |
| Particle Size & Distribution | 20 to 100 microns (average 50 microns) |

Application Description

HVIF Thermospray overlay to blow molded or thermoformed multilayer HDPE-EVOH Plastic Fuel Tanks

| | High | High | | | Cold |
|---|---|---|---|---|---|
| | Pressure | Pressure | Liquid | Liquid | Liquid |
| Cylinder | Oxygen | Hydrogen | Propylene | Nitrogen | Nitrogen |
| Supply | 165 | 175 | 125 | | |
| Pressure | | | | | |
| Ignition | 30 scfh | 60 scfh | | | |
| Damp Flow | 400 scfh | 60 scfh | | | |
| Run Flow | 380 scfh | | 80 scfh | 30 scfh | 40 scfh |

| Forward Air Frequency Setting | 30 to gun |
|---|---|
| Vacuum Air from gun | n/a |
| Nozzle spot size | 2″ |
| Powder Feed threshold | 30 psi |
| Canister | 30 psi |
| Powder Feed lead screw | 200 rpm |
| Powder Feed lbs. Per hr. | 25-30 approx. |
| Auxiliary Cooling Forced Air | Y split gun to auxiliary |
| | jet Frequency setting 30 |
| Preheat | n/a |
| First Pass | Center of pinch 90 degrees Straight on |
| Second Pass | 15 degree bottom of pinch Seam area |
| Third Pass | 15 degrees top of pinch seam |
| FourthPass | Center of pinch 90 degrees Straight on |
| Post heat | n/a |
| Spray Distance | 6″ end of shroud to substrate |
| | Surface 6-8″ |
| Gun travel speed | n/a |
| Tank rotation speed | 600 ipm |
| Oscillation Frequency | n/a |
| Oscillation width | n/a |
| Overlap distance | approx. ½″ bead to bead width |
| Oscillation indwell-outdwell | n/a |
| time duration | |
| Proximity | Manual Control |
| Overlay thickness | per 1 pass .005″ |
| Overlay thickness | .025″ |

Preparation

Surface preparation of excess trim on pinch was milled off at approx. 80 thousandths of an inch measuring from sidewalls to top of pinch. Pinch did not overheat and open up during spraying operations. Surface Cleaning and Electro Arc Plasma treatment of the pinch area and fuel tank surfaces were done.

### EXAMPLE 4

### EVOH by Eval Co. Ethylene-Vinyl Alcohol Copolymer

The 398 EVOH processes very well through the HVIF thermospray system. It is used as a multilayer film in blow molded HDPE automotive fuel tanks. EVA can be applied to HDPE using HVIF spray equipped with a special nozzle for welding two parts together using EVOH as filler material in preparing a weld joint. Prep configurations can use nozzles with spray spot diameter sizes of ⅛″, ¼″ and ⅜″. For EVOH weld overlay films on pinch areas only, a 2″ spot size nozzle is implemented. For EVOH weld overlay film “to spray the entire fuel tank surface area”, a special Fan nozzle is used that sprays an 8 to 12″ wide spot size.

EVOH 398 was HVIF Sprayed onto HDPE or EVOH substrate gas tanks and then treated by an Electro Arc Plasma Treatment Cleaning process. The treated materials provided pull test results of up to 3700 psi per 1 sq. inch without disbanding (electrometer pull tester). However, EVOH needs further development as the material is prone to stress and cracking under the drop test and the impact test. Special additives and flow adjustments are being explored.

Parameters

Material EVOH 378 HVIF overlay to blow molded or thermoformed multi-Layer HDPE-EVOH plastic fuel tanks, pinch areas outside dia. Surface overlay films, liners and surface weld overlay attachments

| | High | | | | |
|---|---|---|---|---|---|
| | Pressure | High Pressure | High Pressure | | |
| Cylinder | Oxygen | Hydrogen | Propylene | | |
| Supply | 165 psi | 175 psi | 125 psi | 100 psi | 40 psi |
| pressure | | | | | |

| | |
|---|---|
| Forced Air Frequency Setting | 35 |
| Vacuum Air Frequency Setting | n/a |
| Nozzle Spot size | ½″ ¼″ 2″ 6″ 12″ |
| | Fan |
| Powder Feed threshold | 30 psi |
| Canister | 30 psi |
| Powder Feed lead | 200 rpm |
| Powder Feed lbs. Per hr. to gun | 24 lbs. |
| Auxiliary Cooling forced air frequency setting | 30 |

### EXAMPLE 5

### Anti-Foulant Coating

The present invention contemplates a mold spray lay up of the above aforementioned compositions and composites to form a moisture barrier of non-reinforced thermoplastic and additional reinforced anti-foulant to fiberglass transfer molded to form a permanent coating. Anti-foulant coatings prepared according to the present invention are cost effective for commercial use.

Another suitable thermoplastic antifoulant is Nylon-12 precipitated round shape copper clad powders ranging from 80-20 microns with an average particle size of 50 microns. The Nylon-12 and copper form a composite useful for antifoulant thermoplastic when processed through the HVIF System. This material is available from The Weidman Co., Fort Myers, Fla.

A batch of powdered coating composition is prepared by mixing 55 lb. Abcite-Suryln Indomer (50 micron particle size) with 15 lbs. PTFE (10 micron particle size), 12 lb. Sea Nine liquid or powdered form (powder form 10 micron particle size), 14 lbs. Of silver/nickel copper clad mica platelets (50 microns), and 4 lbs. Vancide-89, average particle size 50 microns in a water-jacket cooled Henshel blender at 3600 RPM for 2 minutes. This serves to blend the mixture into an even particle distribution mixture without overheating and melting of the particles together.

A High Velocity Oxygen Fuel (HVOF) thermospray gun is used for spraying a melted powder composition of, for example, thermoplastic compounds, thermoplastic/metallic composite or thermoplastic/ceramic composite onto a substrate to form a coating thereon. The gun includes an HVOF generator for providing an HVIF/HVOF gas stream to a fluid cooled nozzle. The carrier gas stream is heated to a melt flow process temperature range of from about 168° to about 750° F. A portion of the gas stream is diverted for preheating the powder, with the preheated powder being injected into the main gas stream at a down stream location within the nozzle. Forced cold inert gas sources are provided in a shroud circumscribing the nozzle for cooling the melted powder in flight before deposition onto the substrate. Forced air and vacuum sources are provided in a shroud circumscribing the nozzle for cooling the molten coating to provide a quenched, semi-crystalline state.

Procedures

In preparation of the weld joint configuration, trim is milled off approximately 80 thousandths of an inch high, as distance from the substrate and mating weld walls. To trim too deeply will expose the pinch zone and cause expansion or opening up of the weld area due to overheating of the vulnerable weld zone.

Thorough cleaning of the substrate areas before HVIF Spray, such as removal of oils and dirt as well as mold release, is imperative. The best method of cleaning thermoplastic substrates is through use of Corona Electric Arc Plasma discharge surface treatment equipment and discharge gun. The simplest definition of Corona treating is that it is a way to increase the surface tension of a material. Increased surface tension means that other materials such as a laminating film and printing will adhere better to the treated material. This is accomplished by exposing the air near the material surface to a high voltage electrical discharge, a corona that causes the oxygen molecules in the discharge area to divide into their atomic form. These oxygen atoms are than available to bond with the molecules on the surface of the material being treated thereby changing the surface molecular structure to one that is extremely receptive to the HVIF Thermoplastic Spray Process. The corona discharge blasts away dirt and mold release chemicals if any present. This process eliminates the use of highly volatile organic components or liquid solvents such as MEK or Acetone.

Application in Molding Processes

In addition the present invention contemplates applications in which said HVIF deposited thermoplastic coated materials are transferred onto molds for joining to mating compositions and as integral parts of a complex molded product.

The present invention contemplates using the present invention to replace gel coating entirely or to be combined with gel coating by application of HVIF coatings to gel coats on hull coatings below the water line. The pure thermoplastic of the HVIF process completely seals the fiberglass from moisture eliminating pox on gel coated marine surfaces. The present invention also contemplates additional uses in new constructions using in mold applications and in mold spray up procedures. An examples of use is as follow:
1. Spray antifoulant thermoplastic onto a mold 0.015-20″ thick;
2. Spray a thermoplastic water barrier coating onto the product of step one;
3. Reheat deposited thermoplastic; and
4. Apply chopped fiber, multidirectional woven fabric, or non-directional fabric, etc., to chemically bond to form a vessel hull.

The present invention is not restricted to Indomers, thermoplastic resins, polyamide, EVOH, PVDF, UHMW-PE or PTFE. These are just a few thermoplastic powdered resins usable for processing through the HVIF System. The preferred powder size is 20 to 89 microns with an overall average size of approximately 40-50 microns for any powdered resin used. The dielectric antifoulant/barrier layer is about 4-5 mils thick when sprayed onto an aluminum hull substrate. The dielectric constant of the thermoplastic material is in the range of 8-9. The fabric sheets are about 3 thousandths of an inch in thickness and are overlapped to form an electrical connection throughout the surface hull area. The composite is then electronically integrated to an electronic power supply. Additional thin antifoulant composition prepreg layers of ¾ thousandths of 1 inch (each) can be applied over the fabric.

The present invention therefore provides novel non-polar and/or non-polarizable polymer corrosion resistant coatings and a system and methods for applying these coatings. It is understood that certain modifications to the invention may be made as might occur to one skilled in the field of the invention within the scope of the appended claims. All embodiments contemplated hereunder that achieve the objects of the invention have therefore not been shown in complete detail. Other embodiments may be developed without departing from the spirit of the invention nor from the scope of the appended claims.

While now HVIF sprayed and chemically bonded overlays of higher performance to lower performance thermoplastic sheets and preformed plastic parts as well as materials for and methods of forming same have been disclosed as examples, there could be a wide range of changes incorporated without departing from the scope and spirit of the present invention. Thus it is intended that the foregoing detailed description be regarded as illustrative rather than limiting and that it be understood that it is the following claims, including all equivalents, which are intended to define the scope of the Invention.

1. A method for applying a corrosion resistant non-polar polymer coating to a substrate comprising the steps of:
(a) providing a source of non-polar polymer powder,
(b) generating a high temperature thermal spray of said powder for spraying said powder onto a substrate;
(c) introducing into said thermal spray at least one gas for substantially displacing or reacting with oxygen in said thermal spray and substantially preserving the non-polar character of said powder during the step of spraying said powder onto a substrate; and
(d) applying said powder as a coating onto said substrate using said thermal spray.

2. The method of claim 1 wherein said non-polar polymer powder comprises a thermoplastic type polymer selected from the group consisting of polyethylene, ultra-high molecular weight polyethylene, high density polyethylene, polypropylene, nylon, polytetrafluoroethylene, polystyrene, polyester, acrylic, polymethylmethacrylate, acrylonitrile butadiene styrene, polyvinyl-chloride, polybutylene, polycarbonate, polyaramid, polysulfone, polyimide, tar, wax, latex, polyurethane, polyvinylidene chloride, cellulose acetate, phenolics, nitrophenolics, polyetheretherketone, and phenol-formaldehyde, or a thermoset type polymer selected from the group consisting of polyester, epoxy, acrylic, vinyl ester, polyurethane, phenolic, styrene butadiene, silicone, polyamide, polyurea, polysulfone, and nitrophenolics.

3. The method of claim 1 wherein the step of generating a high temperature thermal spray of said powder is performed using a thermal spray gun.

4. The method of claim 3 wherein said powder is sprayed at a velocity of about 10 to 900 mph.

5. The method of claim 4 wherein said powder is sprayed at a velocity of about 700 mph.

6. The method of claim 1 wherein said polymer powder is in the size range of from about 1 to about 250 microns.

7. The method of claim 1 wherein said at least one gas is selected from the group consisting of carbon dioxide, nitrogen, argon, helium, krypton, carbon monoxide, neon, hydrogen, methane, ethane, propane, butane, pentane, hexane, heptane, octane, nonane, decane, alcohols, acetylene, propylene, ethylene, butylene, pentylene, hexylene, septylene, octylene and hydrogen sulfide.

8. The method of claim 7 wherein the step of introducing at least one gas is performed using a gas mixture consisting essentially of 90% carbon dioxide and 10% hydrogen.

9. The method of claim 1 further comprising the steps of providing said substrate, cleaning a surface of said substrate to which said polymer coating is to be applied, and roughening said surface to a roughness of about 0.002 inch average prior to the application of said polymer coating.

10. A method for applying a corrosion resistant non-polar polymer coating to a substrate comprising the steps of:
(a) providing a substrate for receiving a polymer coating;
(b) spraying onto said substrate a layer of metal fibers or particles;
(c) providing a source of non-polar polymer powder;
(d) generating a high temperature thermal spray of said powder for spraying said powder onto said substrate;
(e) introducing into said thermal spray at least one gas for substantially displacing or reacting with oxygen in said thermal spray and substantially preserving the non-polar character of said powder during the step of spraying said powder onto a substrate; and
(f) applying said powder as a coating onto said substrate using said thermal spray.

11. The method of claim 10 wherein the step of spraying said substrate with a layer of metal fibers or particles is performed using a thermal spray process.

12. The method of claim 10 wherein said non-polar polymer powder comprises a thermoplastic type polymer selected from the group consisting of polyethylene, ultra-high molecular weight polyethylene, high density polyethylene, polypropylene, nylon, polytetrafluoroethylene, polystyrene, polyester, acrylic, polymethylmethacrylate, acrylonitrile butadiene styrene, polyvinyl-chloride, polybutylene, polycarbonate, polyaramid, polysulfone, polyamide, tar, wax, latex, polyurethane, polyvinylidene chloride, cellulose acetate, phenolics, nitrophenolics, polyetheretherketone, and phenol-formaldehyde, or a thermoset type polymer selected from the group consisting of polyester, epoxy, acrylic, vinyl ester, polyurethane, phenolic, styrene butadiene, silicone, polyamide, polyurea, polysulfone, and nitrophenolics.

13. The method of claim 10 wherein the step of generating a high temperature thermal spray of said powder is performed using a thermal spray gun.

14. The method of claim 13 wherein said powder is sprayed at a velocity of about 10 to 900 mph.

15. The method of claim 14 wherein said powder is sprayed at a velocity of about 700 mph.

16. The method of claim 10 wherein said polymer powder is in the size range of from about 1 to about 250 microns.

17. The method of claim 10 wherein said at least one gas is selected from the group consisting of carbon dioxide, nitrogen, argon, helium, krypton, carbon monoxide, neon, hydrogen, methane, ethane, propane, butane, pentane, hexane, heptane, octane, nonane, decane, alcohols, acetylene, propylene, ethylene, butylene, pentylene, hexylene, septylene, octylene and hydrogen sulfide.

18. The method of claim 17 wherein the step of introducing at least one gas is performed using a gas mixture consisting essentially of 90% carbon dioxide and 10% hydrogen.

19. The method of claim 10 wherein said substrate is selected from the group of plastics and metals.

20. The method of claim 19 wherein the substrate is a plastic container.

21. The method of claim 19 wherein the substrate is a plastic fuel container.

22. The method of claim 19 wherein the substrate is a metal container.

23. The method of claim 19 wherein the substrate is a metal fuel container.

24. The method of claim 19 wherein the substrate is a plastic hull of a marine vessel.

25. The method of claim 19 wherein the substrate is a metal hull of a marine vessel.

26. The method of claim 1 used in making a plastic container further comprising the steps of:
a. Blow molding two plastic ½ sheet half-shells, each with an i.d. and an o.d.;
b. HVIF spraying one relatively thick film, 0.020 to 0.025″ of a non-polar polymer powder onto the i.d. of said ½ shells and covering all surfaces thereof to form a pinch area with a pinch area i.d. and a pinch area o.d.;
c. Spraying said pinch area extra thickly;
d. Optionally attaching to the ½ shells attachments comprising an attachment o.d. and an attachment i.d. and selected from the group of stubs, vent valves, and other attachments;
e. Spray welding to join said attachments as needed to said ½ shells;
f. Spraying said pinch area i.d. of said pinch area and said attachment i.d. of said attachments to seal all parts together;
g. Installing a fuel pump assembly and fuel lines as needed; and
h. Assembling said two ½ shells into a plastic container.

27. The method of claim 1 further comprising the steps of:
a. Providing an HVIF/HVOF (high velocity oxygen fuel) system using an appropriate speed, selected from subsonic and supersonic gas speeds;
b. Injecting a powder coating composition into an internal pre-plastification injection zone in a gun nozzle;
c. Melting said powder without overheating said powder into molten particles;
d. Directing said molten particles in flight substantially in one direction into an expanded nozzle with an hot carrier gas and a gas selected from the group of at least one cold inert shielding gas, at least one reducing gas, and combinations thereof;
e. Spraying said melted composition onto a surface to be coated thereby forming a molten coating on said surface; and
f. Concurrently cooling said surface and said molten coating to a semi-crystalline state.

28. The method of claim 1 further comprising the steps of:
a. HVIF Spraying thermoplastic powder onto a substrate to form a thermoplastic coating;
b. Heating said thermoplastic coating into a semi-molten state;
c. Applying a fabric with a pressure roller to adhere said fabric to said thermoplastic coating;
d. Cooling said thermoplastic to a semi-crystalline state;
e. Optionally, HVIF spraying a second coat over said substrate of a prepared coating composition comprising non-reinforced thermoplastic, antifoulant, and conductive additives;
wherein when said second coat is applied, said thermoplastic coating is free of antifoulant resin.

29. A coating composition applied by the method of claim 1 wherein said powder is comprised of about 45-65% by weight of Indomer, about 15-20% by weight of PTFE thermoplastic, about 10-30% by weight of biodegradable antifoulant, about 10-30% by weight of antifoulant copper/nickel silver clad mica flakes, and about 2 to 4% by weight of biocide antifoulant.
